(19) United States
(12) Patent Application Publication
(10) Pub. No.: US 2018/0099505 A1
(43) Pub. Date: Apr. 12, 2018

(54) LIQUID CONTAINER AND A LIQUID EJECTION APPARATUS

(71) Applicant: SEIKO EPSON CORPORATION, Tokyo (JP)

(72) Inventors: Katsumi YAMADA, Matsumoto (JP); Satoshi NAKATA, Matsumoto (JP); Kazuhisa KAWAKAMI, Matsumoto (JP); Katsunari KUMAGAI, Okaya (JP)

(21) Appl. No.: 15/723,465

(22) Filed: Oct. 3, 2017

(30) Foreign Application Priority Data
Oct. 6, 2016 (JP) 2016-198141

(51) Int. Cl. B41J 2/175

(52) U.S. Cl. CPC B41J 2/1752; B41J 2/17553

(57) ABSTRACT

A liquid container and a liquid ejection apparatus for the liquid ejection apparatus is provided. A hook portion provided on a +Z direction side wall portion that is positioned on the +Z direction side or a +X direction side wall portion that is positioned on the +X direction side when the liquid container is mounted to a mount portion is configured to restrict movement of the liquid container from the mount portion in the +Z direction by engaging with one of the outer face on the +X direction side in a moving body, the outer face on the +X direction side of a rotation lever, a gap in the Z direction formed between the wall on the +X direction side of the moving body and the rotation lever.

### CROSS REFERENCE TO RELATED APPLICATIONS

This application claims priority to Japanese Application No. 2016-198141 filed on Oct. 6, 2016. The entire disclosure of this Japanese application is expressly incorporated by reference herein.

### BACKGROUND

### 1. Technical Field

The present invention relates to a liquid container and a liquid ejection apparatus.

### 2. Related Art

Heretofore, liquid ejection apparatuses are known in which a plurality of liquid containers are removably arranged on a carriage that is equipped with a liquid ejection head, and moves reciprocally. In such liquid ejection apparatuses, a liquid container is mounted to the carriage in a state of being positioned thereon by engaging a portion of the liquid container with a portion of a rotation lever provided on the carriage, while the liquid container configured to be removed from the carriage by rotating the rotation lever in an engagement releasing direction (for example, see JP-A-2014-28499).

JP-A-2014-28499 is an example of related art.

Incidentally, a liquid container arranged on the carriage needs to be removed and replaced by a new liquid container when the amount of the liquid contained inside falls below a certain amount. In such a case, conventionally, after the user rotates the rotation lever in the engagement releasing direction, and removes the old liquid container, a new liquid container is mounted at that position in a state where a portion of the new liquid container is engaged with a portion of the rotation lever. In such a case, it is preferable that an operation of mounting/removing the liquid container can be performed easily, but it is preferable that a mounted state of the liquid container after being mounted to the carriage is maintained favorably.

### SUMMARY

The invention has been made in view of such an actual condition, and an advantage of some aspects of the invention is to provide a liquid container and a liquid ejection apparatus that can easily perform the operation of mounting/removing the liquid container to/from the liquid ejection apparatus, and can meanwhile favorably maintain the mounted state of the liquid container after being mounted.

The vertical direction is assumed to be a Z direction, a direction orthogonal to the Z direction is assumed to be an X direction, a direction orthogonal to both the Z direction and the X direction is assumed to be a Y direction, the vertical upward direction in the Z direction is assumed to be a +Z direction, while the vertical downward direction is assumed to be a −Z direction, and the positive direction in the X direction is assumed to be a +X direction, while the negative direction is assumed to be a −X direction.

One aspect for solving the above-described issue is a liquid container configured to be mounted to/removed from a mount portion of a liquid ejection apparatus including a box, a head that ejects liquid, a moving body that is equipped with the head, and moves along the X direction in the box, and when the liquid is not ejected from the head, stands by in an end portion on the +X direction side in the box, the mount portion provided on the moving body, and a rotation lever provided at a position on the +X direction side in the mount portion so as to be rotatable centered on a shaft line along the Y direction.

A state where the liquid container is mounted on the mount portion is assumed to be a mounted state. In the mounted state, the liquid container has a +Z direction side wall portion that is positioned on the +Z direction side and a +X direction side wall portion that is positioned on the +X direction side. A hook portion is provided on one of the +Z direction side wall portion and the +X direction side wall portion. The hook portion is configured to engage with an engagement portion constituted by one of an outer face on the +X direction side in the moving body, an outer face on the +X direction side in the rotation lever, and a gap in the Z direction formed between a wall on the +X direction side of the moving body and the rotation lever so as to restrict movement of the liquid container from the mount portion in the +Z direction.

According to this aspect, when mounting the liquid container to the mount portion, it suffices that the hook portion only engages with the engagement portion constituted by one of the outer face on the +X direction side in the moving body, the outer face on the +X direction side in the rotation lever, and the gap in the Z direction formed between the wall on the +X direction side of the moving body and the rotation lever. When removing the liquid container from the mount portion, it suffices to release the engagement state of the hook portion with the engagement portion. Therefore, the operation of mounting/removing the liquid container to/from the mount portion can be performed easily. In addition, in a state where the hook portion is in engagement with the engagement portion, movement of the liquid container in the +Z direction is restricted, and thus the mounted state on the mount portion can be held favorably.

In the above-described liquid container, it may be preferable that a +X direction side engaging portion is provided on the +X direction side wall portion, and in the mounted state, the +X direction side engaging portion engages with a +X direction side engagement portion provided in the rotation lever in a state of abutting against the +X direction side engagement portion from the −Z direction side.

According to this configuration, the +X direction side engaging portion engages with the +X direction side engagement portion, which is a portion of the rotation lever, from the −Z direction side, and thus even if an unintended external force is applied to the hook portion, a risk of being inadvertently removed from the mount portion can be reduced. Therefore, the mounted state on the mount portion can be held more favorably.

It may be preferable that the above-described liquid container further includes a −X direction side wall portion positioned on the −X direction side in the mounted state, and in the mounted state, a −X direction side engaging portion is provided on the −X direction side wall portion, the −X direction side engaging portion engages with a −X direction side engagement portion provided in a side wall on the −X direction side of the mount portion in a state of abutting against the −X direction side engagement portion from the −Z direction side.

According to this configuration, on the +X direction side, the hook portion engages with the engagement portion, while on the −X direction side, the −X direction side engaging portion engages with the −X direction side engagement portion of the mount portion in a state of abutting against the −X direction side engagement portion from the −Z direction side. Therefore, the mounted state of the liquid container on the mount portion can be favorably held in a more stable manner.

In the above-described liquid container, it may be preferable that the hook portion configured to rotate centered on a shaft along the Y direction, the hook portion has an engaging portion that engages with the engagement portion, and an operation portion provided at a position on the opposite side to the engaging portion with the shaft therebetween, the operation portion is biased by a biasing member in a direction in which the engaging portion engages with the engagement portion, and engagement of the hook portion with the engagement portion is released by shifting the operation portion against a biasing force of the biasing member.

According to this configuration, engagement of the hook portion with the engagement portion is supported by the biasing force of the biasing member, and becomes more stable. Therefore, the mounted state of the liquid container on the mount portion can be held in a stable manner. In addition, if the operation portion is shifted against the biasing force, the engagement of the hook portion with the engagement portion is released, and thus the operation of mounting/removing the liquid container can be performed easily.

In the liquid ejection apparatus to which the above-described liquid container is mounted, it may be preferable that the mount portion is configured such that a plurality of the liquid containers are mounted so as to be aligned in the Y direction, and a plurality of the rotation levers are provided in the mount portion at positions corresponding to the liquid containers. In the above-described liquid container that is mounted to such a liquid ejection apparatus, it may be preferable that the hook portion is configured to be engaged at a position between the rotation levers adjacent in the Y direction in the mount portion.

According to this configuration, for example, even if the rotation lever has a defect, the liquid container can be mounted to the mount portion without being affected by the defect.

In the liquid ejection apparatus to which the above-described liquid container is mounted, it may be preferable that the mount portion is configured such that a plurality of the liquid containers are mounted so as to be aligned in the Y direction, and a plurality of the rotation levers are provided in the mount portion at positions corresponding to of the liquid containers. In the above-described liquid container that is mounted to such a liquid ejection apparatus, it may be preferable that the hook portion is configured to extend in the −Z direction while passing between the rotation levers adjacent in the Y direction in the mount portion, then curve in the Y direction, and engage with the engagement portion.

According to this configuration, the size of the hook portion can be reduced in the +X direction.

One aspect for solving the above-described issue is a liquid ejection apparatus including a box, a head that ejects liquid, a moving body that is equipped with the head, and moves along the X direction in the box, and when the liquid is not ejected from the head, stands by in an end portion on the +X direction side in the box, a mount portion provided on the moving body, and a rotation lever provided at a position on the +X direction side in the mount portion so as to be rotatable centered on a shaft line along the Y direction.

A state where the liquid container is mounted to the mount portion is assumed to be a mounted state. A cover that covers, in the mounted state, a wall portion on the +Z direction side of the liquid container is attached to the moving body.

The cover has a hook portion having an engagement function. The hook portion is configured to engage with an engagement portion constituted by one of an outer face on the +X direction side in the moving body, an outer face on the +X direction side in the rotation lever, and a gap in the Z direction formed between a wall on the +X direction side of the moving body and the rotation lever so as to restrict movement of the liquid container from the mount portion in the +Z direction.

According to this aspect, when mounting the liquid container to the mount portion, it suffices that the liquid container is arranged in the mount portion, and after that, the hook portion of the cover, which covers the liquid container, engages with the engagement portion. When removing the liquid container from the mount portion, it suffices that the engagement of the hook portion with the engagement portion is released, and after that, the liquid container is removed from the mount portion. Therefore, the operation of mounting/removing the liquid container to/from the mount portion can be performed easily. In addition, in a state where the hook portion of the cover is in engagement with the engagement portion, movement of the liquid container in the +Z direction is restricted by the cover, and thus the mounted state of the liquid container on the mount portion can be held favorably.

In the above-described liquid ejection apparatus, it may be preferable that the hook portion configured to rotate centered on a shaft along the Y direction, the hook portion has an engaging portion that engages with the engagement portion, and an operation portion provided at a position on the opposite side to the engaging portion with the shaft therebetween, the operation portion is biased by a biasing member in a direction in which the engaging portion engages with the engagement portion, and engagement of the hook portion with the engagement portion is released by shifting the operation portion against a biasing force of the biasing member.

According to this configuration, engagement of the hook portion with the engagement portion is supported by the biasing force of the biasing member, and becomes more stable. Therefore, the mounted state of the liquid container on the mount portion can be held in a stable manner. In addition, if the operation portion is shifted against the biasing force, the engagement of the hook portion with the engagement portion is released, and thus the operation of mounting/removing the liquid container can be performed easily.

In the above-described liquid ejection apparatus, it may be preferable that the mount portion is configured such that a plurality of the liquid containers are mounted so as to be aligned in the Y direction, and a plurality of the rotation levers are provided in the mount portion at positions corresponding to the liquid containers. It may be preferable that the hook portion of the cover is configured to be engaged at a position between the rotation levers adjacent in the Y direction in the mount portion.

According to this configuration, for example, even if the rotation lever has a defect, the cover can be attached to the mount portion, and the liquid container can be mounted to the mount portion, without being affected by the defect.

In the above-described liquid ejection apparatus, it may be preferable that the mount portion is configured such that a plurality of the liquid containers are mounted so as to be aligned in the Y direction, and a plurality of the rotation levers are provided in the mount portion at positions corresponding to the liquid containers. It may be preferable that the hook portion is configured to extend in the −Z direction while passing between the rotation levers adjacent in the Y direction in the mount portion, then curve in the Y direction, and engage with the engagement portion.

According to this configuration, the size of the hook portion of the cover can be reduced in the +X direction.

In addition, in the above-described liquid ejection apparatus, it may be preferable that an end portion on the −X direction side of the cover is supported by an outer face on the −X direction side in the moving body so as to be rotatable centered on the shaft along the Y direction.

According to this configuration, in a state where the cover is attached to the moving body, the cover can be shifted between a closed position at which the mount portion is covered and an open position at which the mount portion is opened. Therefore, a risk of losing the cover can be reduced.

One aspect for solving the above-described issue is a liquid container configured to be mounted to/removed from a mount portion of a liquid ejection apparatus including a box, a head that ejects liquid, a moving body that is equipped with the head, and moves along the X direction in the box, and when the liquid is not ejected from the head, stands by in an end portion on the +X direction side in the box, the mount portion provided on the moving body, a rotation lever provided at a position on the +X direction side in the mount portion so as to be rotatable centered on a shaft line along the Y direction, and a step portion provided on a face on the −X direction side of an end portion on the +Z direction side of the rotation lever.

A state where the liquid container is mounted on the mount portion is assumed to be a mounted state. In the mounted state, the liquid container has a +X direction side wall portion that is positioned on the +X direction side. A hook portion is provided in the +X direction side wall portion. The hook portion is constituted by a movable engaging member having an engaging portion that engages with the step portion of the rotation lever. The hook portion is configured to restrict movement of the liquid container from the mount portion in the +Z direction, by the engaging portion engaging with the step portion of the rotation lever.

According to this aspect, when mounting the liquid container to the mount portion, it suffices for the liquid container to be moved toward the bottom portion of the mount portion (in the −Z direction) until the engaging portion of the movable engaging member engages with the step portion of the rotation lever. The step portion of the rotation lever functions as an engagement portion with which the engaging portion of the hook portion engages. The movable engaging member can move so as not to prevent movement of the liquid container until the engaging portion engages with the step portion of the rotation lever. When removing the liquid container from the mount portion, it suffices that the engagement of the engaging portion with the step portion of the rotation lever is released by moving the movable engaging member, and the liquid container is then removed from the mount portion. Therefore, the operation of mounting/removing the liquid container to/from the mount portion can be performed easily. In addition, in a state where the engagement portion (the step portion) is in engagement with the hook portion, movement of the liquid container in the +Z direction is restricted, and thus the mounted state of the liquid container on the mount portion can be held favorably.

One aspect for solving the above-described issue is a liquid ejection apparatus including a box, a head that ejects liquid, a moving body that is equipped with the head, and moves along the X direction in the box, and when the liquid is not ejected from the head, stands by in an end portion on the +X direction side in the box, a mount portion provided on the moving body, and a rotation lever provided at a position on the +X direction side in the mount portion so as to be rotatable centered on a shaft line along the Y direction.

A cover that covers a wall portion on the +Z direction side of a liquid container is attached to the moving body in a mounted state in which the liquid container is mounted on the mount portion.

Hook portions having an engagement function are provided respectively in two end portions in the Y direction of the cover. The hook portions are configured to respectively engage with outer faces on two sides in the Y direction of the moving body so as to restrict movement of the liquid container from the mount portion in the +Z direction.

According to this configuration, when mounting the liquid container to the mount portion, it suffices that the liquid container is arranged in the mount portion, and after that, the cover that covers the liquid container is attached such that the hook portions of the cover engage with the engagement portions of the moving body. On the other hand, when removing the liquid container from the mount portion, if the cover is moved in a direction in which the engagement state of the hook portion with the engagement portion is released, the liquid container can be removed from the mount portion. Therefore, the operation of mounting/removing the liquid container to/from the mount portion can be performed easily. In addition, in a state where the hook portions of the cover are in engagement with the engagement portions, movement of the liquid container in the +Z direction is restricted by the cover, and thus the mounted state of the liquid container on the mount portion can be held favorably.

### BRIEF DESCRIPTION OF THE DRAWINGS

The invention will be described with reference to the accompanying drawings, wherein like numbers reference like elements.

FIG. 1 is a perspective view showing the appearance of a liquid ejection apparatus.

FIG. 2 is a perspective view showing the internal structure of the liquid ejection apparatus.

FIG. 3 is a perspective view showing a carriage to which a liquid container according to a first embodiment is mounted.

FIG. 4 is a perspective view showing the internal structure of the carriage.

FIG. 5 is a perspective view of the liquid container when viewed obliquely from above.

FIG. 6 is a perspective view of the liquid container when viewed obliquely from below.

FIG. 7 is a partial plan view of the liquid ejection apparatus in which the carriage is positioned at a home position.

FIG. 8 is a cross-sectional view along a line arrow 8-8 in FIG. 7.

FIG. 9 is a cross-sectional view showing a state of the liquid container before being mounted.

FIG. 10 is a cross-sectional view showing a state of the liquid container that is being mounted.

FIG. 11 is a cross-sectional view showing a state of the liquid container after being mounted.

FIG. 12 is a cross-sectional view showing a state of the liquid container that is being removed.

FIG. 13 is a perspective view showing a carriage to which a liquid container according to a second embodiment is mounted.

FIG. 14 is a cross-sectional view showing a state of the liquid container after being mounted.

FIG. 15 is a cross-sectional view showing a state of a liquid container according to a third embodiment after being mounted.

FIG. 16 is a cross-sectional view showing a state of the liquid container that is being mounted.

FIG. 17 is a cross-sectional view showing a state of a liquid container according to Modified Example 2 after being mounted.

FIG. 18 is a perspective view showing a carriage to which a liquid container according to Modified Example 3 is mounted.

FIG. 19 is a cross-sectional view showing a state of the liquid container after being mounted.

FIG. 20 is a perspective view showing a carriage to which a liquid container according to Modified Example 4 is mounted.

FIG. 21 is a side view showing the carriage to which the liquid container is mounted.

FIG. 22 is a cross-sectional view showing a state of the liquid container after being mounted.

FIG. 23 is a perspective view of a liquid container according to a fourth embodiment when viewed obliquely from front and above.

FIG. 24 is a perspective view of a liquid container when viewed obliquely from behind and above.

FIG. 25 is a perspective view showing a carriage to which a liquid container is mounted using a cover.

FIG. 26 is a cross-sectional view showing a state of a liquid container after being mounted using a cover.

FIG. 27 is a cross-sectional view showing a state of a liquid container before being mounted using a cover.

FIG. 28 is a cross-sectional view showing a state of a liquid container that is being mounted using a cover.

FIG. 29 is a cross-sectional view showing a state of a liquid container after being mounted using a cover according to Modified Example 6.

FIG. 30 is a perspective view showing carriage to which a liquid container is mounted using a cover according to Modified Example 7.

FIG. 31 is a cross-sectional view showing a state of a liquid container after being mounted using a cover.

FIG. 32 is a perspective view showing a carriage to which a liquid container is mounted using a cover according to Modified Example 8.

FIG. 33 is a perspective view showing a carriage to which a liquid container is mounted using a cover according to Modified Example 9.

FIG. 34 is a perspective view of a liquid container according to a fifth embodiment.

FIG. 35 is a cross-sectional view showing a state of a liquid container after being mounted.

FIG. 36 is a cross-sectional view showing a state of a liquid container that is being mounted.

FIG. 37 is a perspective view of a cover according to a sixth embodiment.

FIG. 38 is a perspective view showing a carriage to which a liquid container is mounted using a cover.

### DESCRIPTION OF EXEMPLARY EMBODIMENTS

Embodiment of a liquid container and a liquid ejection apparatus will be described below with reference to the drawings. The liquid container in the following embodiments is an ink cartridge that contains ink, which is an example of liquid. In addition, the liquid ejection apparatus is an inkjet printer that performs printing by ejecting ink supplied from an ink cartridge onto paper, which is an example of a medium. In addition, the printer is a printer whose printing method is so-called serial printing in which printing is performed by moving a liquid ejection head (hereinafter, briefly referred to as a “head”) along a main scanning direction intersecting the conveyance direction of paper.

Furthermore, the X-Y-Z coordinate system in the drawings is assumed to be as follows. Specifically, the X direction is a direction of movement (the main scanning direction) of a carriage (a moving body) that is equipped with the liquid container, and moves, and coincides with the width direction of the liquid ejection apparatus. In addition, the Y direction is the depth direction of the liquid ejection apparatus, and coincides with the conveyance direction and discharge direction of paper. In addition, the Z direction is the vertical direction, and coincides with the height direction of the liquid ejection apparatus.

Regarding the Z direction, the vertical upward direction that is on the upper side of the apparatus is assumed to be a +Z direction, and the vertical downward direction that is on the lower side of the apparatus is assumed to be a −Z direction. In addition, regarding the Y direction, a direction on the back side of the apparatus is assumed to be a +Y direction, and a direction on the front side of the apparatus on which paper is discharged is assumed to be a −Y direction. Regarding the X direction, in the right and left direction when the apparatus is viewed from the front, a direction on the right side of the apparatus is assumed to be a +X direction (the positive direction), and a direction on left side of the apparatus is assumed to be a −X direction (the negative direction).

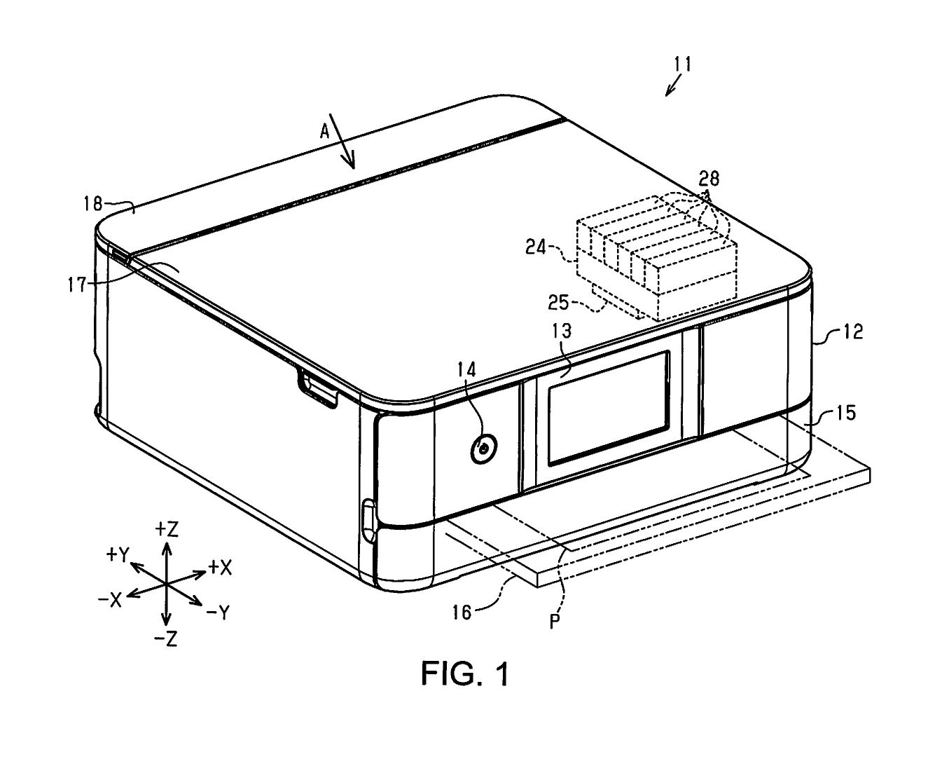

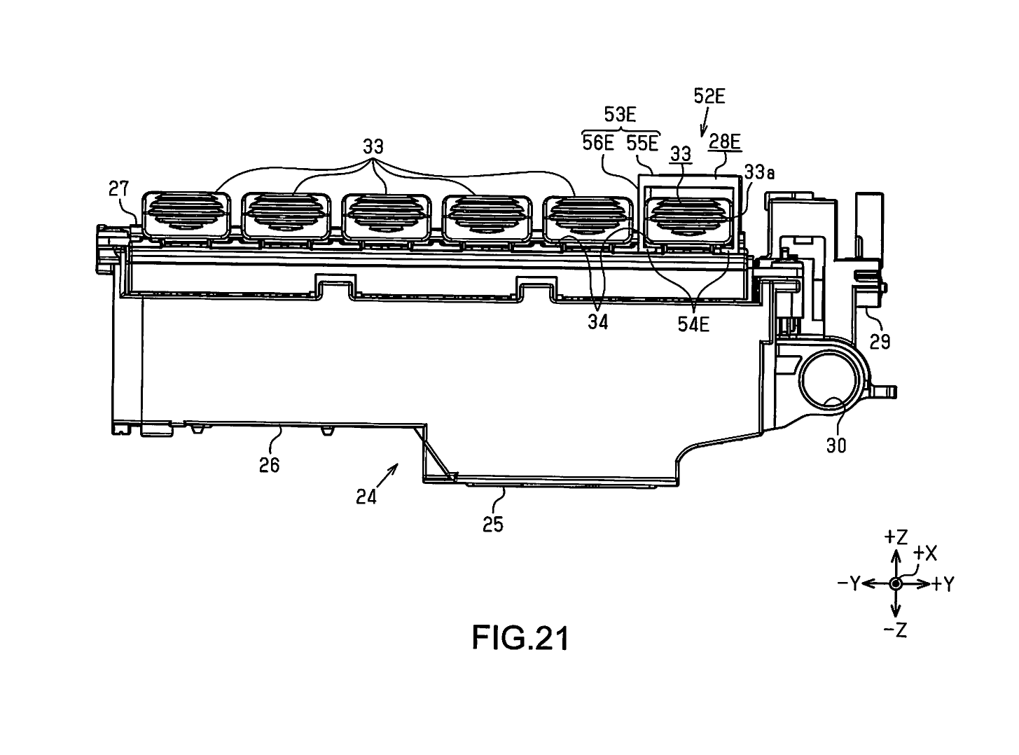

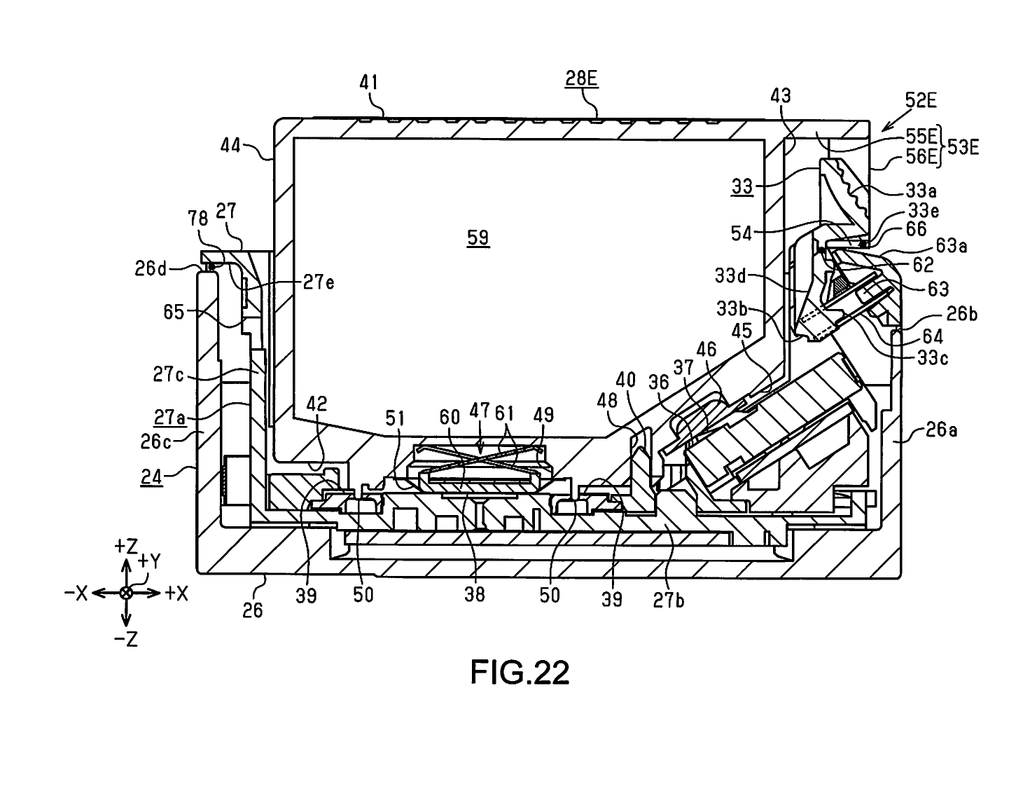

Moreover, a state where the liquid container is mounted to a mount portion of the carriage is assumed to be a “mounted state”. Note that in FIGS. 1 to 38, the same reference numerals are assigned to the same constituent elements.

### First Embodiment

As shown in FIG. 1, a liquid ejection apparatus 11 has a rectangular parallelepiped-shaped box 12. For example, an operation panel 13 that has a touch panel type liquid crystal display screen is provided at a substantially central position in the right and left direction of an upper portion of the front face (the face on the −Y direction side) of the box 12. This operation panel 13 is used when performing various operations in the liquid ejection apparatus 11. Note that a power button 14 is provided on the left side of the operation panel 13 when the front face of the box 12 is viewed from the front.

In addition, a front face movable panel 15 that constitutes a portion of the front face of the box 12 is provided at a position below the operation panel 13 in the front face of the box 12. The front face movable panel 15 is mounted to the box 12 to be rotatable centered on a shaft along the right and left direction. Specifically, the front face movable panel 15 is provided to be openable/closable relative to the box 12. FIG. 1 shows a state where the front face movable panel 15 is closed. When paper P is discharged to a discharge tray 16, the front face movable panel 15 opens, and the discharge tray 16 is pulled out from the inside of the box 12 as indicated by a dashed double-dotted line in FIG. 1.

In addition, a ceiling plate panel 17 and an upper face movable panel 18 are provided on the upper face of the box 12 (the face on the +Z direction side). The ceiling plate panel 17 and the upper face movable panel 18 constitute the upper face of the box 12. The ceiling plate panel 17 occupies substantially the entire region of the upper face of the box 12, and the upper face movable panel 18 is provided in the end portion on the back side (the +Y direction side). The upper face movable panel 18 is mounted to the box 12 to be rotatable centered on a shaft along the right and left direction. In other words, the upper face movable panel 18 is provided so as to openable/closable relative to the box 12. FIG. 1 shows a state where the upper face movable panel 18 is closed. If the upper face movable panel 18 is opened, the paper P can be inserted into the box 12 in a direction indicated by an arrow A in FIG. 1.

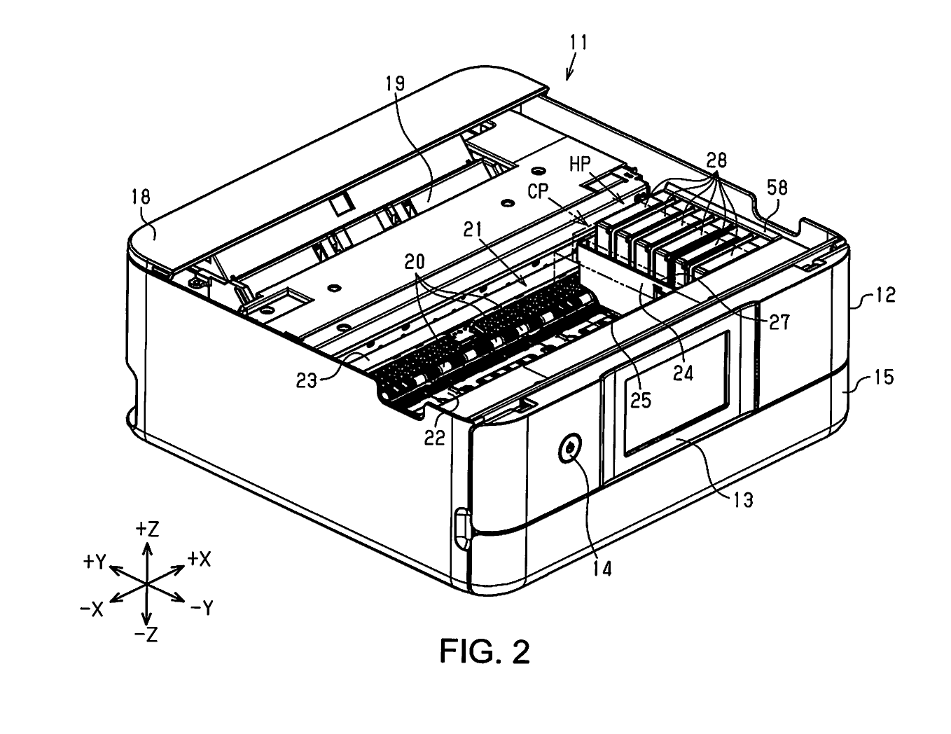

FIG. 2 shows a state where the inside of the box 12 is overviewed with the ceiling plate panel 17 being removed from the state shown in FIG. 1. As shown in FIG. 2, a sheet-feeding guide path 19 is provided at a position closer to the back portion in the box 12. The paper P inserted into the box 12 after opening the upper face movable panel 18 is guided to the front side of the box 12 by the sheet-feeding guide path 19. In addition, a paper storage portion (not illustrated) configured to store the paper P in a stacked state is provided at a position below the discharge tray 16 in the box 12. This paper storage portion can be mounted to/removed from the inside of the box 12 by opening the front face movable panel 15.

The paper P stored in the paper storage portion is first conveyed to the back side (the +Y direction side) of the box 12 by a conveyance mechanism configured including a conveyance roller 20 and the like, curves upward, is then reversed to the front side, passes, on the downstream side (the −Y direction side), through the confluence portion with the downstream end of the sheet-feeding guide path 19, and, after that, is conveyed to a printing unit 21 that performs printing onto the paper P. The printing unit 21 has a supporting member 22 that supports, from below, the paper P conveyed to the downstream side relative to the conveyance roller 20, a box-shaped carriage (moving body) 24 configured to move reciprocally along a guide shaft 23 in the right and left direction (the main scanning direction) on the supporting member 22, and a head 25 that is mounted at a lower portion of the carriage 24, and can eject ink (liquid) downward.

Next, the configuration of the carriage 24 will be described.

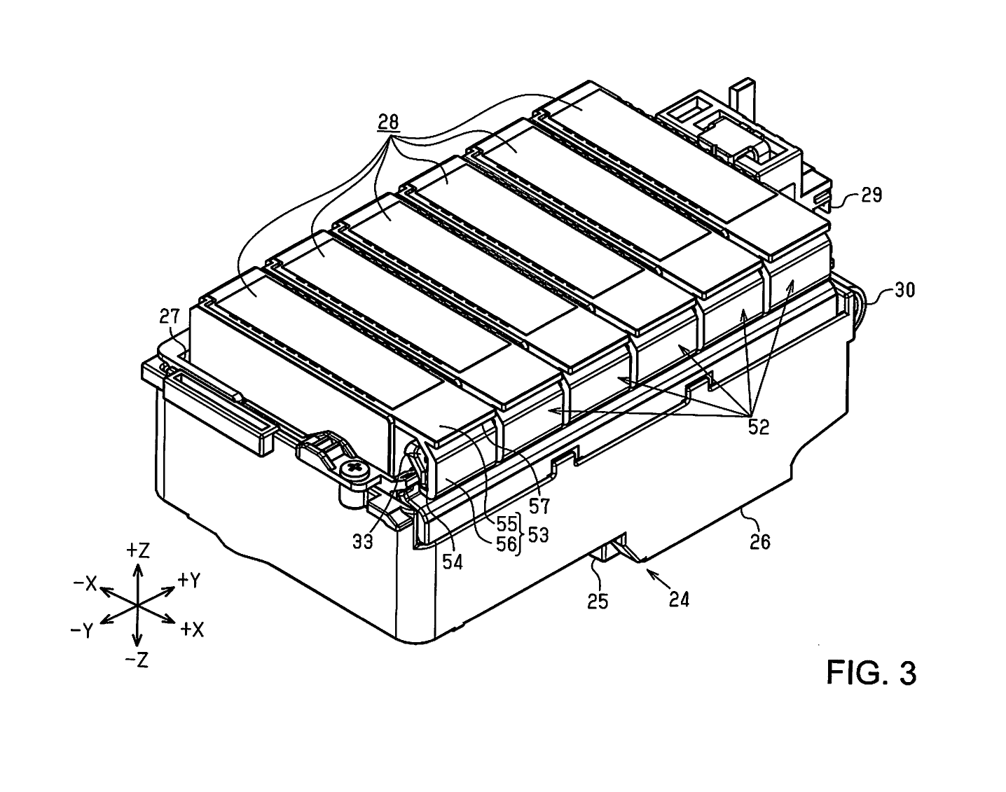

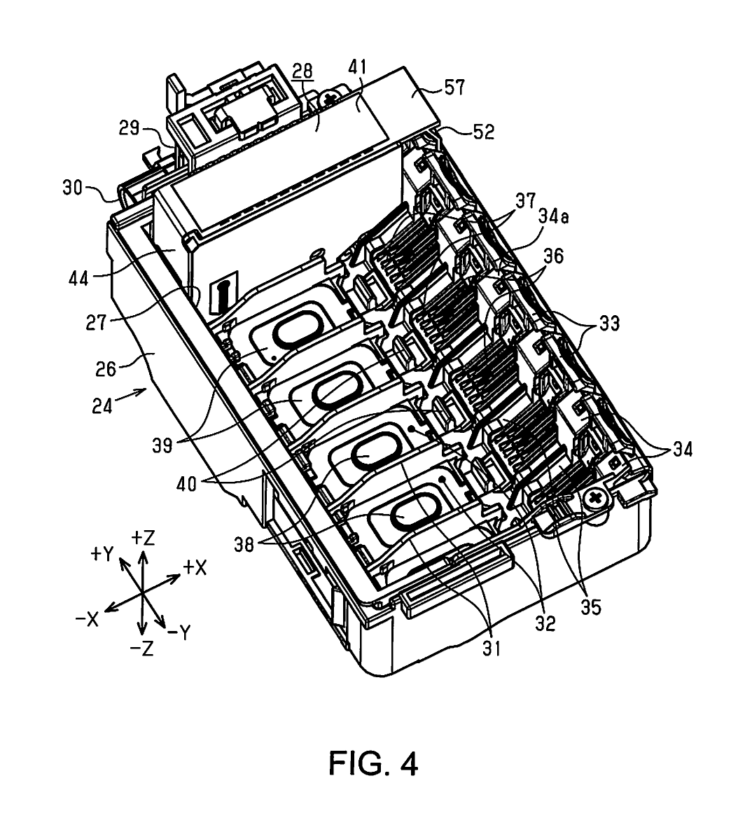

As shown in FIGS. 3 and 4, the carriage 24 has a box-shaped case 26 whose upper portion is open and a mount portion 27 provided in a state where an upper portion thereof is open to the inside of the case 26. A plurality of (in this embodiment, as an example, six) liquid containers 28 are mounted on the mount portion 27. Incidentally, in the case of this embodiment, the plurality of liquid containers 28 are mounted to the mount portion 27 in an arrangement state of being aligned sequentially in the depth direction (the Y direction) of the apparatus orthogonal to both the vertical direction (the Z direction) and the main scanning direction (the X direction). Note that it suffices for at least one liquid container 28 to be mounted removably to the mount portion 27, and a plurality of the liquid containers 28 do not necessarily need to be mounted.

In addition, a belt coupling portion 29 and a bearing 30 are provided integrally on the back face (the face on the +Y direction side) of the case 26 of the carriage 24. In the box 12, the belt coupling portion 29 is coupled to a portion of an endless belt (not illustrated) provided to be movable circulatively along a circulative path including a straight path portion that lies along the guide shaft 23. In addition, the bearing 30 is a portion into which the guide shaft 23 is inserted. The carriage 24 slides in the longitudinal direction (the X direction) of the guide shaft 23 in a state where the guide shaft 23 is inserted into this the bearing 30. A portion of the endless belt reciprocally moves on the straight path portion in the circulative path according to driving of a carriage driving mechanism (not illustrated). The carriage 24 is guided by the guide shaft 23 to move reciprocally in the right and left direction (the main scanning direction) according to this reciprocal movement.

As shown in FIG. 4, the inside of the mount portion 27 is partitioned by a plurality of (in this embodiment, as an example, five) partition walls 31 into mount regions 32 whose widths (the size in the Y direction) respectively correspond to the widths of the liquid containers 28. Also, rotation levers 33 are respectively provided for the mount regions 32, in the upper portions on the +X direction side (the right side when the apparatus is viewed from the front) of the mount portions 27. The rotation levers 33 rotates centered on a shaft line that lies along the Y direction (the depth direction of the apparatus). The rotation levers 33 are provided at positions opposite in the X direction to the end portions on the +X direction side of the respective liquid containers 28 when the liquid containers 28 are mounted to the mount regions 32 of the mount portion 27. In addition, an upper end portion 34a of a CSIC (Customer Service Integrated Circuit) holder 34 is positioned between the rotation levers 33 adjacent in the Y direction (the depth direction of the apparatus) in the mount portion 27.

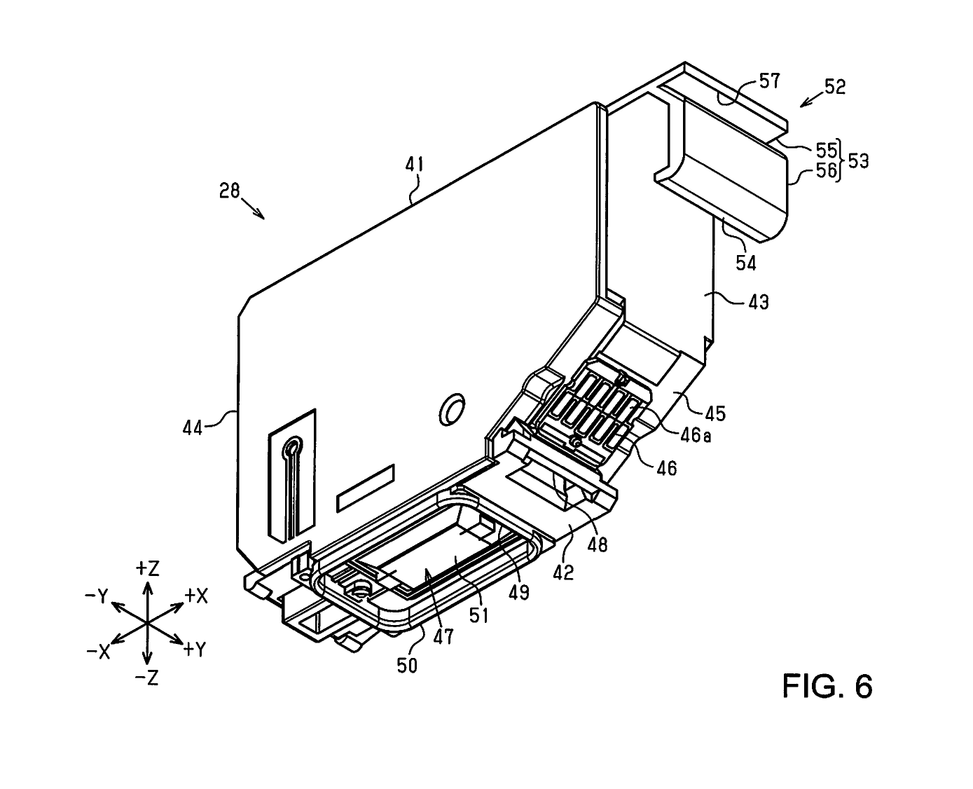

An electrical connection portion 36 is provided on an inclined face portion 35 positioned in the mount region 32 below the CSIC holder 34. The electrical connection portion 36 is connected communicably to a control apparatus (not illustrated) of the liquid ejection apparatus 11. When the liquid container 28 is mounted to the mount portion 27, the electrical connection portion 36 is electrically connected to terminals on a circuit substrate 46 (see FIG. 6) provided on the liquid container 28. By electrically connecting the electrical connection portion 36 to the terminals on the circuit substrate 46 of the liquid container 28, information regarding the type of the ink, the residual amount of the ink and the like is exchanged between the liquid container 28 and the liquid ejection apparatus 11. The electrical connection portion 36 is constituted by an elastic metal member. The electrical connection portion 36 has a movable contact portion 37 protruding toward the inside of the mount portion 27. When the liquid container 28 is mounted to the mount portion 27, the movable contact portion 37 and the terminals on the circuit substrate 46 of the liquid container 28 come into contact with each other. In addition, at this time, the electrical connection portion 36 elastically deforms according to the contact pressure with the terminals on the circuit substrate 46. A reaction force accompanied with the elastic deformation is applied as an upward biasing force to the liquid container 28.

As shown in FIG. 4, in the mount portion 27, a liquid introduction portion 38 is provided in the bottom portion of each of the mount regions 32. When the liquid container 28 is mounted to the mount portion 27, the liquid introduction portion 38 is connected to a liquid supplying portion 47 of the liquid container 28 (see FIG. 6). The liquid introduction portion 38 then introduces ink supplied from the liquid container 28. An annular sealing member 39 surrounding the liquid introduction portion 38 is provided in the periphery of the liquid introduction portion 38. The sealing member 39 is an elastic member made of synthetic rubber or the like. The sealing member 39 elastically deforms when the liquid supplying portion 47 of the liquid container 28 is connected to the liquid introduction portion 38. A reaction force accompanied with the elastic deformation is applied as an upward biasing force to the liquid container 28. In addition, in the mount region 32 of the mount portion 27, a positioning protrusion 40 is provided at a position between the electrical connection portion 36 and the liquid introduction portion 38. The positioning protrusion 40 protrudes vertically upward from the bottom portion of the mount region 32. The positioning protrusion 40 is received by a positioning recession 48 (see FIG. 6) provided on the liquid container 28 when the liquid container 28 is mounted to the mount portion 27.

Next, the configuration of the liquid container 28 will be described.

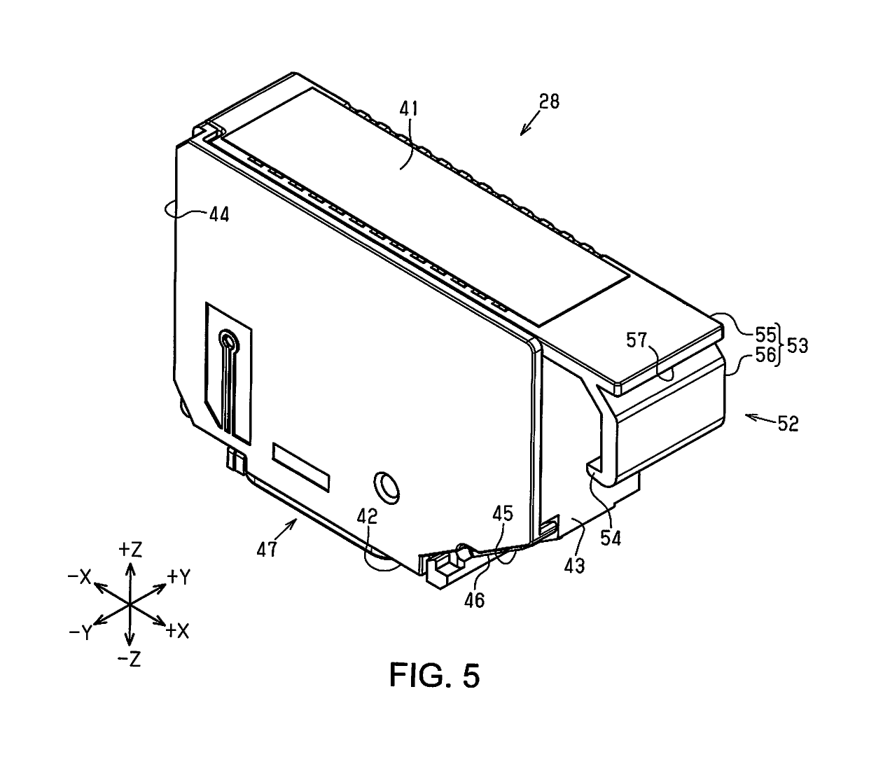

As shown in FIGS. 5 and 6, the liquid container 28 has a rectangular parallelepiped shape. The liquid container 28 is provided with a +Z direction side wall portion 41 (an upper wall) positioned on the +Z direction side (the vertically upper side) when mounted to the mount portion 27 (see FIG. 3), a −Z direction side wall portion 42 (a bottom wall) positioned on the −Z direction side (the vertical lower side), a +X direction side wall portion 43 (a right side wall portion) positioned on the +X direction side (the right side) on which the rotation lever 33 (see FIG. 3) is provided, and a −X direction side wall portion 44 (a left side wall portion) positioned on the −X direction side (the left side) that is opposite to the +X direction side wall portion 43. In addition, an inclined face portion 45 is formed between the −Z direction side wall portion 42 and the +X direction side wall portion 43 in the liquid container 28. The inclined face portion 45 opposes the inclined face portion 35 (see FIG. 4) provided below the CSIC holder 34 when the liquid container 28 is mounted to the mount portion 27.

The circuit substrate 46 is provided on the inclined face portion 45 of the liquid container 28. The liquid supplying portion 47 is provided in the −Z direction side wall portion 42 of the liquid container 28. In the −Z direction side wall portion 42 of the liquid container 28, the positioning recession 48 is formed at a position on the inclined face portion 45 side relative to the liquid supplying portion 47. Note that a storage element (not illustrated) that stores information regarding the type of the ink of the liquid container 28, the residual amount of the ink, and the like is provided on the circuit substrate 46. In addition, as described earlier, a terminal 46a that comes into contact with the movable contact portion 37 of the electrical connection portion 36 (see FIG. 4) on the mount portion 27 side when the liquid container 28 is mounted to the mount portion 27 is provided on the circuit substrate 46.

The liquid supplying portion 47 is provided with a liquid supplying hole 49 for suppling ink to the liquid introduction portion 38 on the mount portion 27 side, an annular protrusion 50 formed so as to surround the liquid supplying hole 49, and a filter member 51 that covers, inward of the annular protrusion 50, the opening of the liquid supplying hole 49. The filter member 51 is constituted by a sheet material permeable to liquid but impermeable to gas. When the liquid container 28 is mounted to the mount portion 27, the annular protrusion 50 first abuts against the sealing member 39 that surrounds the liquid introduction portion 38, and subsequently, the filter member 51 comes into contact with the liquid introduction portion 38.

In addition, as shown in FIGS. 5 and 6, a hook portion 52 that has an engagement function is provided in the end portion on the +X direction side of the +Z direction side wall portion 41 (which is also the end portion on the +Z direction side of the +X direction side wall portion 43) of the liquid container 28. The hook portion 52 has an arm portion 53 that extends in the +X direction from a corner portion at which the +Z direction side wall portion 41 and the +X direction side wall portion 43 in the liquid container 28 intersect, and after that extends in the −Z direction. A nail shaped engaging portion 54 is provided at the tip of the arm portion 53. The arm portion 53 is a portion that covers the rotation lever 33 from outside when the liquid container 28 is mounted to the mount portion 27. The arm portion 53 has a first portion 55 positioned on the +Z direction side of the rotation lever 33 and a second portion 56 positioned on the +X direction side of the rotation lever 33. A handle portion 57 is provided so as to extend in the +X direction from the end portion on the +X direction side of the first portion 55 in the arm portion 53 of the hook portion 52. The handle portion 57 is used when the user removes the liquid container 28 mounted on the mount portion 27.

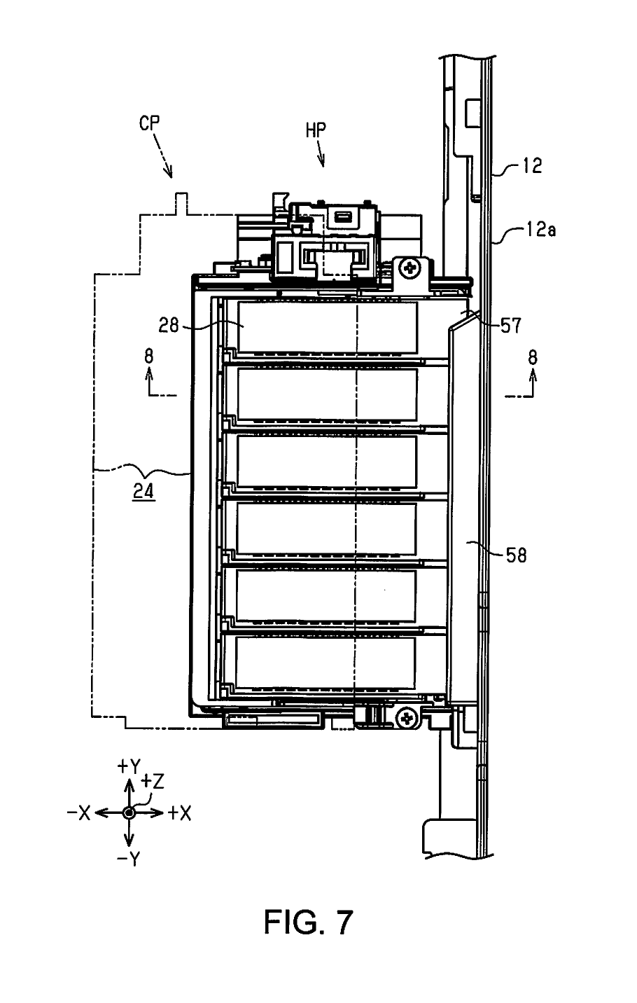

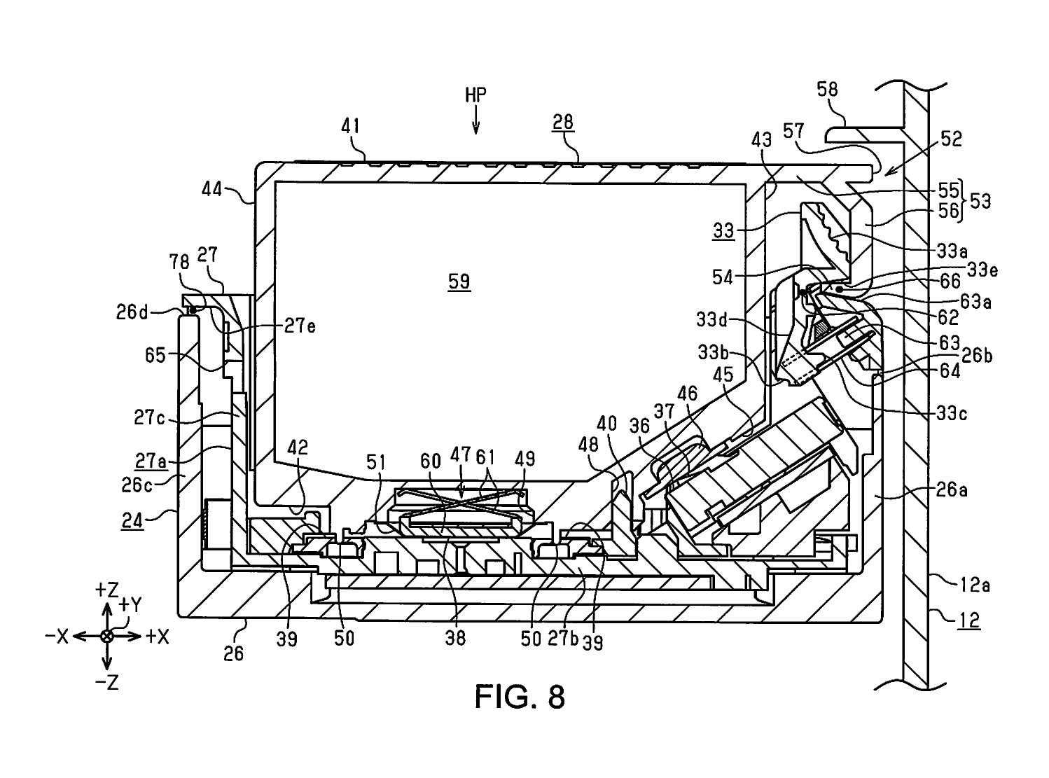

As shown in FIGS. 7 and 8 (and FIG. 2), in the liquid ejection apparatus 11 of this embodiment, a home position HP at which the carriage 24 is stopped (stands by) during maintenance of the head 25 mounted on the carriage 24 and when the power supply of the apparatus is off is set in an end portion on the +X direction side in the box 12. Specifically, during maintenance such as head cleaning, the carriage 24 moves from a printing region, which is a region above the supporting member 22, to the home position HP positioned in the +X direction, and at the home position HP, the head 25 is maintained by a maintenance mechanism such as a suction cap (not illustrated).

During maintenance, it is not preferred that the liquid container 28 is inadvertently removed from the mount portion 27 on the carriage 24. Therefore, a removal suppressing portion 58 configured to suppress removal of the liquid container 28 from the mount portion 27 on the carriage 24 that is positioned (stands by) at the home position HP is provided on the inner face of a side wall 12a on the +X direction side in the box 12. The removal suppressing portion 58 is provided slightly vertically above the +Z direction side wall portion 41 of the liquid container 28 mounted on the mount portion 27 of the carriage 24 so as to protrude on the −X direction side from the inner face of the side wall 12a on the +X direction side, and to extend along the Y direction that is the depth direction of the apparatus. The position at which the removal suppressing portion 58 is provided is not limited to the inner face of the side wall 12a. As long as removal of the liquid container 28 can be suppressed, the removal suppressing portion 58 may be provided at a location other than the inner face of the side wall 12a.

Therefore, if the carriage 24 in which the liquid container 28 is mounted on the mount portion 27 stops at the home position HP, the liquid container 28 mounted on the mount portion 27 is brought into a state where the tip end of the handle portion 57 for removal on the hook portion 52 is covered by the removal suppressing portion 58 from above. Specifically, the removal suppressing portion 58 and the handle portion 57 of the hook portion 52 of the liquid container 28 oppose each other in the vertical direction (the Z direction) via a slight gap into which a fingertip cannot be inserted, and partially overlap in the main scanning direction (the X direction). As a result, when the carriage 24 stops at the home position, the user is inhibited from placing his or her finger tip on the handle portion 57, and thus inadvertent removal of the liquid container 28 from the mount portion 27 on the carriage 24 is suppressed.

On the other hand, as indicated by a dashed double-dotted line in FIG. 7 (and FIG. 2), a change position CP at which the liquid container 28 can be mounted to/removed from the mount portion 27 of the carriage 24 for replacement is set at a position on the −X direction side relative to the home position HP in the box 12. At this change position CP, the handle portion 57 of the hook portion 52 on the liquid container 28 mounted on the mount portion 27 of the carriage 24 and the eaves-like removal suppressing portion 58 do not overlap in the main scanning direction (the X direction). Therefore, when removing and replacing the liquid container 28, the carriage 24 is moved to the change position CP, and at this change position CP, the user can place his or her finger tip on the handle portion 57, and remove the liquid container 28 from the mount portion 27.

As shown in FIG. 8, the liquid container 28 has a liquid chamber 59 configured to contain ink therein. The liquid chamber 59 is in communication with the liquid supplying hole 49 of the liquid supplying portion 47 via a flow path (not illustrated). A porous member 60 and a spring member 61 are arranged in the liquid supplying hole 49. The porous member 60 is constituted by a foamed body made of synthetic resin, or the like. The spring member 61 is constituted by a leaf spring, and biases the porous member 60 toward the inner face of the filter member 51 that blocks the opening of the liquid supplying hole 49. In addition, as described earlier, the positioning recession 48 is provided in the −Z direction side wall portion 42. When mounting the liquid container 28 to the mount portion 27, the positioning protrusion 40 on the mount portion 27 side is inserted from below into the positioning recession 48 on the liquid container 28 side, and thereby shift of the liquid container 28 in a direction intersecting the vertical direction (e.g., the X direction) is suppressed.

As shown in FIG. 8, when the liquid container 28 is mounted to the mount portion 27, a portion of the rotation levers 33 (in this case, the upper end portion) is covered from outside by the arm portion 53 of the hook portion 52 in the liquid container 28. The rotation lever 33 has an operation portion 33a that is pressed and operated by a fingertip when the rotation lever 33 is rotated, in a portion of the rotation lever 33 above a shaft line 62 serving as a rotation center. When the liquid container 28 is mounted to the mount portion 27, this operation portion 33a is covered by the hook portion 52 of the liquid container 28.

In addition, a +X direction side engagement portion 33b is provided in a portion of the rotation lever 33 below the shaft line 62 serving as the rotation center of the rotation lever 33. The +X direction side engagement portion 33b restricts movement of an article (e.g., the liquid container 28) that is about to move vertically upward (the +Z direction) by being engaged with a portion of the article vertically from above. This +X direction side engagement portion 33b is provided in a portion on the −X direction side in the lower end portion of the rotation lever 33. In the lower end portion of the rotation lever 33, a movable spring engaging portion 33c is formed in a portion on the +X direction side that is the opposite side to the +X direction side engagement portion 33b. An inclined portion 33d is provided in a portion on the −X direction side and below the shaft line 62 of the rotation lever 33. The inclined portion 33d is inclined on the −X direction side toward the +X direction side engagement portion 33b of the lower end of the rotation lever 33.

On the inner face on the +X direction side of the mount portion 27, a fixed spring engaging portion 63 is provided at a position opposed obliquely from above to the movable spring engaging portion 33c on the rotation lever 33. A portion of the fixed spring engaging portion 63 is exposed on the +Z direction side from an upper end 26b of a wall 26a on the +X direction side of the case 26. In other words, the wall and the outer face on the +X direction side of the carriage 24 are constituted by the case 26 and the fixed spring engaging portion 63. A gap 66 in the Z direction is formed between an upper face 63a of the fixed spring engaging portion 63 and a lower face 33e of the operation portion 33a of the rotation lever 33. Accordingly, the gap 66 in the Z direction is formed between the wall on the +X direction side of the carriage 24 and the rotation lever 33. A coil spring 64 that biases the lower end portion of the rotation lever 33 on the −X direction side is installed between the fixed spring engaging portion 63 and the movable spring engaging portion 33c of the rotation lever 33.

An inner wall member 27a is provided in the case 26. An upper portion of the inner wall member 27a is exposed from an upper end 26d of a wall 26c on the −X direction side of the case 26. In other words, the wall and outer face on the −X direction side of the carriage 24 are constituted by the case 26 and the inner wall member 27a. A gap 78 is formed between a lower face 27e of the upper portion of the inner wall member 27a and the upper end 26d of the wall 26c on the −X direction side of the case 26. Accordingly, the gap 78 in the Z direction is formed in the wall on the −X direction side of the carriage 24. In addition, the inner walls on the −Z direction side and the −X direction side (the left side when the apparatus is viewed from the front) of the carriage 24 are constituted by the inner wall member 27a. Accordingly, a bottom wall 27b and a side wall 27c on the −X direction side of the mount portion 27 are constituted by the inner wall member 27a. A −X direction side engagement portion 65 is provided in the side wall 27c. The −X direction side engagement portion 65 restricts movement of an article (for example, the liquid container 28) that is about to move vertically upward (the +Z direction) by being engaged with a portion of the article vertically from above.

As described earlier, in a state where the liquid container 28 is mounted on the mount portion 27 (the mounted state), the electrical connection portion 36 of the mount portion 27 elastically deforms according to the contact pressure with the terminal 46a on the circuit substrate 46, and a reaction force accompanied with the elastic deformation is applied as an upward biasing force to the liquid container 28. Therefore, the liquid container 28 will be biased vertically upward (in the +Z direction), that is, in a direction in which the liquid container 28 is removed from the mount portion 27.

On the other hand, in the mounted state, the engaging portion 54 of the hook portion 52 of the liquid container 28 engages with a predetermined engagement portion in the mount portion 27 so as to restrict vertically upward (the +Z direction) movement of the liquid container 28. In this embodiment, the gap 66 in the Z direction formed between the upper face 63a of the fixed spring engaging portion 63 and the lower face 33e of the operation portion 33a of the rotation lever 33 serves as an engagement portion. In other words, the gap 66 in the Z direction formed between the wall on the +X direction side of the carriage 24 and the rotation lever 33 serves as an engagement portion. If the engaging portion 54 of the hook portion 52 engages with this gap 66, vertically upward (the +Z direction) movement of the liquid container 28 is restricted.

Next, actions of the liquid container 28 and the liquid ejection apparatus 11 of the first embodiment configured as described above will be described with a focus on a case where the liquid container 28 is mounted to/removed from the mount portion 27 on the carriage 24.

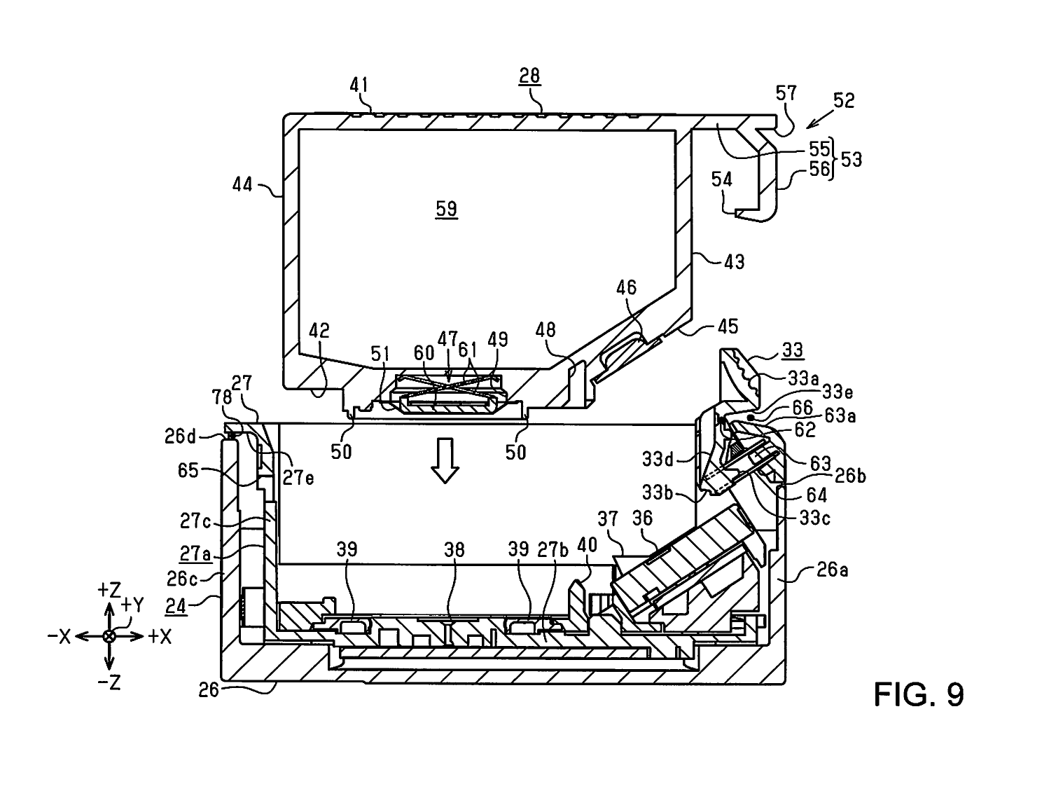

When mounting the liquid container 28 to the mount portion 27, as shown in FIG. 9, the liquid container 28 is moved downward from above the mount portion 27. FIG. 9 illustrates a state where the orientation of the liquid container 28 is held horizontally, and is moved vertically downward in this orientation, but the orientation of the liquid container 28 may be inclined within a range in which the liquid container 28 can be guided to the mount portion 27, and the direction of the movement may be an oblique direction.

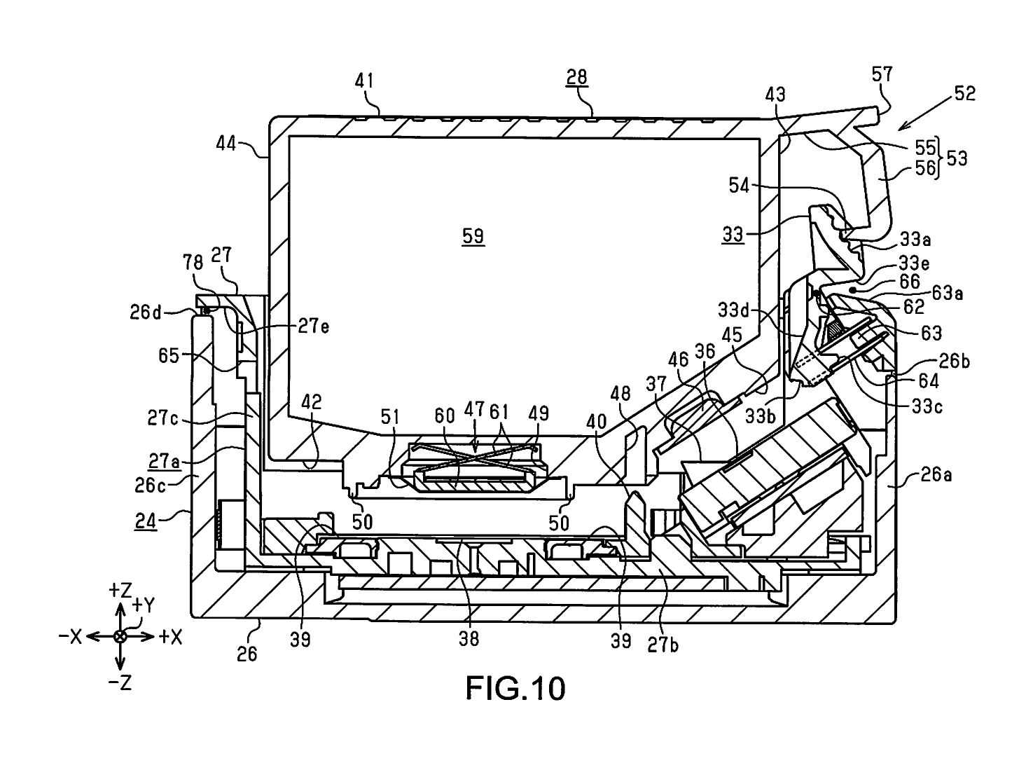

When the liquid container 28 is lowered to some degree to a certain position, as shown in FIG. 10, the engaging portion 54, which is the lower end of the hook portion 52 of the liquid container 28, comes into contact with the surface of the operation portion 33a of the rotation lever 33. Subsequently, when the liquid container 28 is moved downward further from that state, in the hook portion 52, the engaging portion 54 at the tip end of the arm portion 53 slides over the operation portion 33a of the rotation lever 33, and thus a pressing force directed in the +X direction and the +Z direction is applied to the engaging portion 54. As a result, the hook portion 52 flexuously deforms such that at the arm portion 53, the second portion 56 of the rotation lever 33 positioned on the +X direction side opens to the outside. When the liquid container 28 is moved downward further from that state, the engaging portion 54 of the hook portion 52 overrides the lower end of the operation portion 33a in the rotation lever 33 in the −Z direction.

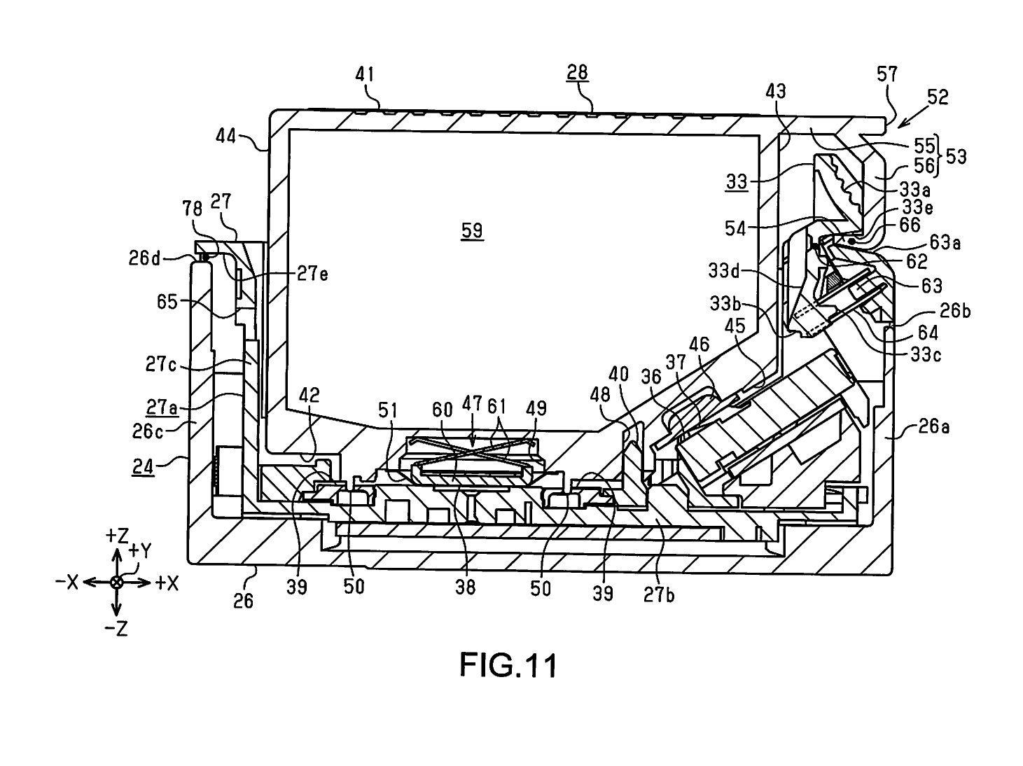

As shown in FIG. 11, the arm portion 53 of the hook portion 52 that deformed flexuously then restores elastically so as to cover at least a portion of the operation portion 33a of the rotation lever 33, and on the +X direction side relative to the mount portion 27, the engaging portion 54 enters the gap 66 between the upper face 63a of the fixed spring engaging portion 63 and the lower face 33e of the operation portion 33a of the rotation lever 33. Subsequently, the engaging portion 54 of the hook portion 52 engages with this gap 66, and mounting of the liquid container 28 to the mount portion 27 is complete. Vertically upward (the +Z direction) movement of the liquid container 28 is restricted by engaging the engaging portion 54 of the hook portion 52 with the gap 66 serving as an engagement portion, and thus the liquid container 28 is held on the mount portion 27 favorably. Furthermore, at least a portion of the operation portion 33a of the rotation lever 33 is covered by the hook portion 52, and thus unexpected movement of the rotation lever 33 due to an unintended external force being applied to the operation portion 33a is also suppressed.

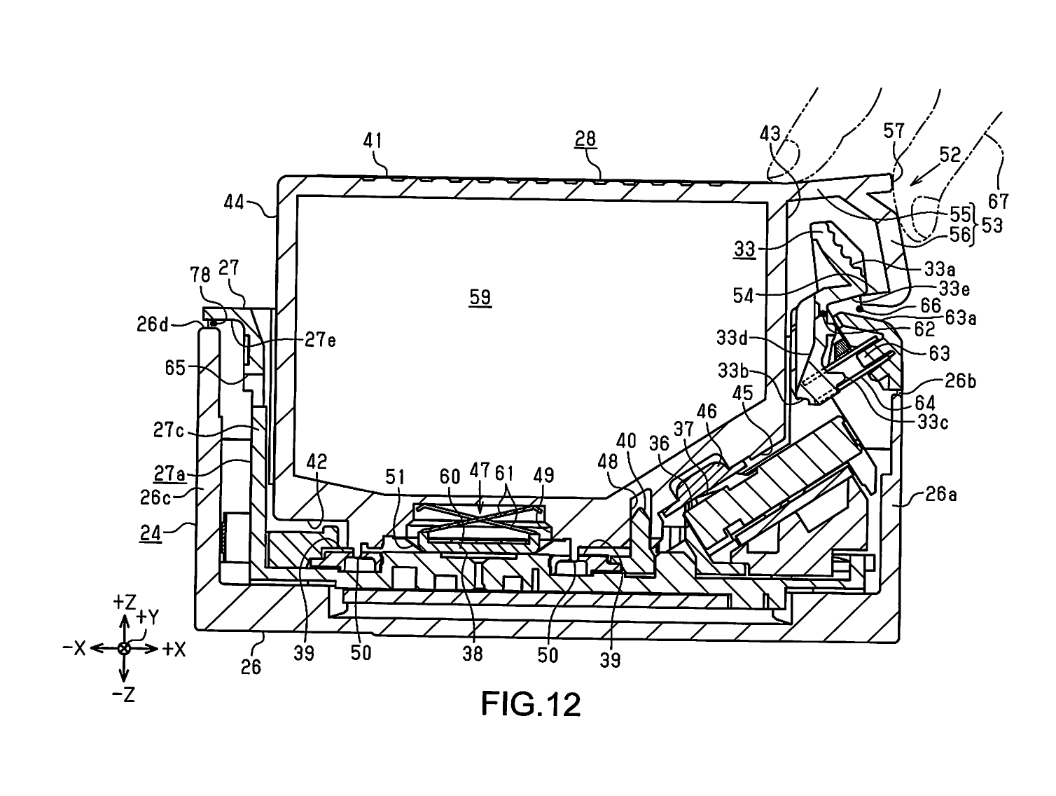

When removing the liquid container 28 from the mount portion 27, as shown in FIG. 12, the user places a fingertip 67 on the handle portion 57, and lifts the handle portion 57 upward. The arm portion 53 of the hook portion 52 then deforms flexuously, and the engaging portion 54 comes off from the gap 66 serving as an engagement portion. In this manner, the engagement state of the hook portion 52 with the gap 66 serving as the engagement portion is released, and the liquid container 28 is removed from the mount portion 27 without the rotation lever 33 being operated.

According to the above first embodiment, the following effects can be acquired.

(1) When mounting the liquid container 28 to the mount portion 27, the liquid container 28 is moved toward the inside of the mount portion 27, and the hook portion 52 is engaged with the gap 66 (engagement portion) in the Z direction formed between the wall on the +X direction side of the carriage 24 and the rotation lever 33, whereby the liquid container 28 is mounted to the mount portion 27 in an engagement state. Therefore, the operation of mounting the liquid container 28 to the mount portion 27 can be performed easily.

(2) On the other hand, when removing the liquid container 28 from the mount portion 27, the liquid container 28 is moved by a hand being placed on the hook portion 52, in a direction in which the engagement state of the hook portion 52 with the gap 66 serving as the engagement portion is released, and thereby the engagement state of the liquid container 28 with the mount portion 27 is released, and the liquid container 28 is removed. Therefore, the operation of removing the liquid container 28 from the mount portion 27 can be performed easily.

(3) In addition, in the mounted state, movement of the liquid container 28 in the +Z direction is restricted by the hook portion 52 engaging with the gap 66 serving as the engagement portion, and thus the mounted state on the mount portion 27 can be held favorably. Therefore, the connection state between the liquid supplying portion 47 of the liquid container 28 and the liquid introduction portion 38 of the mount portion 27, and the connection state between the circuit substrate 46 on the liquid container 28 side and the electrical connection portion 36 on the mount portion 27 side can be held favorably.

(4) Moreover, in a state where the liquid container 28 is mounted on the mount portion 27, the operation portion 33a in the rotation lever 33 is covered by the hook portion 52 from the +Z direction side and the +X direction side, and thus it is possible to suppress application of an unexpected external force to the operation portion 33a, and to reduce a risk that the liquid container 28 is unexpectedly removed due to the rotation lever 33 being moved in an unnecessary manner.

### Second Embodiment

Next, a second embodiment will be described with a focus on differences from the first embodiment.

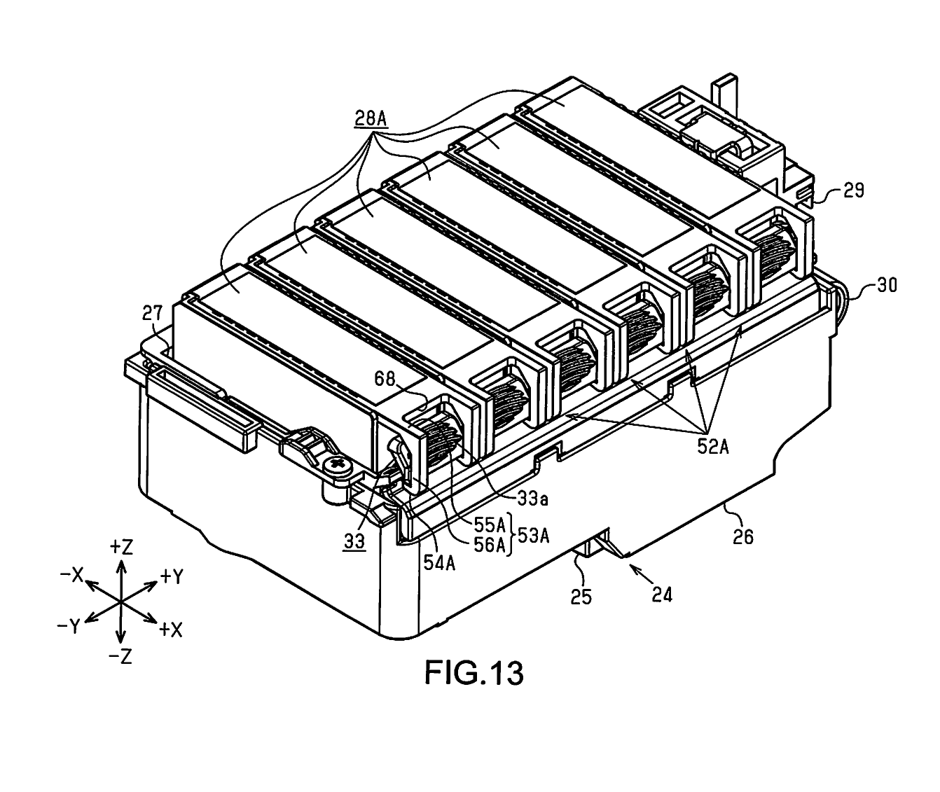

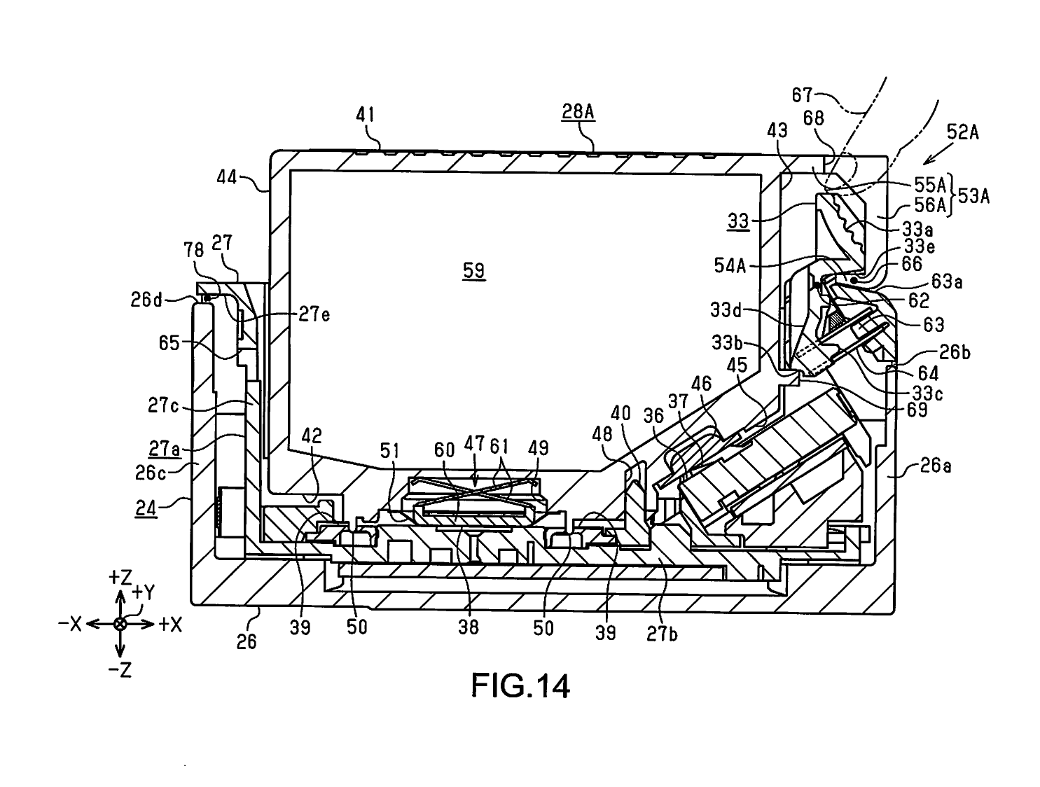

As shown in FIGS. 13 and 14, in a liquid container 28A of the second embodiment, an opening portion 68 is formed in an arm portion 53A of a hook portion 52A, which will be a portion that covers a rotation lever 33 from outside, when the liquid container 28A is mounted to a mount portion 27. In the arm portion 53A, the opening portion 68 is formed from a half way of the X direction of a first portion 55A that is positioned on the +Z direction side of the rotation lever 33 to a portion on the +X direction side and over the entirety in the Z direction of a second portion 56A that is positioned on the +X direction side of the rotation lever 33. The opening portion 68 exposes an operation portion 33a of the rotation lever 33 to the outside. Therefore, the user can press the operation portion 33a of the rotation lever 33 against a biasing force of a coil spring 64 by inserting a fingertip 67 into this opening portion 68.

In addition, as shown in FIG. 14, a +X direction side engaging portion 69 is provided on the outer face of a +X direction side wall portion 43 in the liquid container 28A. The +X direction side engaging portion 69 is a protrusion protruding in the +X direction from the outer face of the +X direction side wall portion 43. This +X direction side engaging portion 69 is provided at a position abutting against, from the −Z direction side, a +X direction side engagement portion 33b formed in the lower end portion of the rotation lever 33 in a state where the liquid container 28A is mounted to the mount portion 27 (a mounted state). In the mounted state, the hook portion 52A engages with a gap 66 in the Z direction formed between the wall on the +X direction side of a carriage 24 and the rotation lever 33. In addition, the +X direction side engaging portion 69 engages with the +X direction side engagement portion 33b of the rotation lever 33 from the −Z direction side. If the hook portion 52A engages with the gap 66, and the +X direction side engaging portion 69 engages with the rotation lever 33, vertically upward (the +Z direction) movement of the liquid container 28 is restricted.

When mounting the liquid container 28A to the mount portion 27, the liquid container 28A is moved downward from above the mount portion 27. If the liquid container 28A is lowered to some extent to a certain position, the +X direction side engaging portion 69 comes into contact with an inclined portion 33d of the rotation lever 33. If the liquid container 28 is moved further downward from that state, the +X direction side engaging portion 69 moves in the −Z direction while being in contact with the inclined portion 33d of the rotation lever 33. At this time, the rotation lever 33 is pressed in the +X direction by the +X direction side engaging portion 69, and thus slightly moves in a direction that is indicated as the counterclockwise direction in FIG. 14, against the biasing force of the coil spring 64.

In addition, at this time, the operation portion 33a provided in the upper end portion of the rotation lever 33 shifts on the −X direction side compared to the state shown in FIG. 14. As a result, the hook portion 52A moves in the −Z direction, while barely coming into contact with the surface of the operation portion 33a, that is, without accompanying very large flexural deformation. If the liquid container 28A is moved further downward, the +X direction side engaging portion 69 overrides the lower end of the inclined portion 33d of the rotation lever 33 in the −Z direction. In addition, an engaging portion 54A of the hook portion 52A overrides the lower end of the operation portion 33a in the rotation lever 33 in the −Z direction.

The rotation lever 33 that has rotated in the counterclockwise direction by being pressed by the +X direction side engaging portion 69 is then pressed back by the coil spring 64 in the clockwise direction. As a result, the engaging portion 54A of the hook portion 52A engages with the gap 66 between an upper face 63a of a fixed spring engaging portion 63 and a lower face 33e of the operation portion 33a of the rotation lever 33. In addition, the +X direction side engaging portion 69 engages with the +X direction side engagement portion 33b of the rotation lever 33 in a state of abutting against the +X direction side engagement portion 33b from the −Z direction side. Vertically upward (the +Z direction) movement of the liquid container 28A is restricted by engaging the hook portion 52A with the gap 66 serving as an engagement portion, and engaging the +X direction side engaging portion 69 with the +X direction side engagement portion 33b of the rotation lever 33. Therefore, the liquid container 28A is favorably held on the mount portion 27.

When removing the liquid container 28A from the mount portion 27, as shown in FIG. 14, the user inserts the fingertip 67 into the opening portion 68 of the hook portion 52A, and presses the operation portion 33a of the rotation lever 33 against the biasing force of the coil spring 64 using the fingertip 67. The engagement state between the +X direction side engaging portion 69 and the +X direction side engagement portion 33b of the rotation lever 33 is then released. In addition, the gap 66 enlarges, and a force for engaging the engaging portion 54A at the tip end of the hook portion 52A weakens. The liquid container 28A is lifted upward from that state. The arm portion 53A of the hook portion 52A then slightly deforms flexuously, overrides the lower end of the operation portion 33a, and moves in the +Z direction. In this manner, the engagement state between the hook portion 52A and the gap 66 serving as an engagement portion is released, and the liquid container 28A is removed from the mount portion 27.

According to the above second embodiment, effects similar to the above-described effects (1) to (3) in the first embodiment can be acquired, and the following effects can be further acquired.

(5) In the liquid container 28A that is in the mounted state, the +X direction side engaging portion 69 engages with the +X direction side engagement portion 33b, which is a portion of the rotation lever 33, from the −Z direction side. Therefore, even if an unintended external force is applied to the hook portion 52A, it is possible to reduce a risk that the liquid container 28A is inadvertently removed from the mount portion 27, and the mounted state on the mount portion 27 can be held more favorably.

(6) When removing the liquid container 28A from the mount portion 27, it suffices that by the operation portion 33a of the rotation lever 33 being pressed by the fingertip 67 inserted from the opening portion 68 of the hook portion 52A, the rotation lever 33 is rotated in a direction in which the engagement state with the +X direction side engaging portion 69 is released, and the liquid container 28A is lifted. Therefore, when it is necessary to remove the liquid container 28A from the mount portion 27, the liquid container 28A can be easily removed from the mount portion 27.

### Third Embodiment

Next, a third embodiment will be described with a focus on differences from the first embodiment.

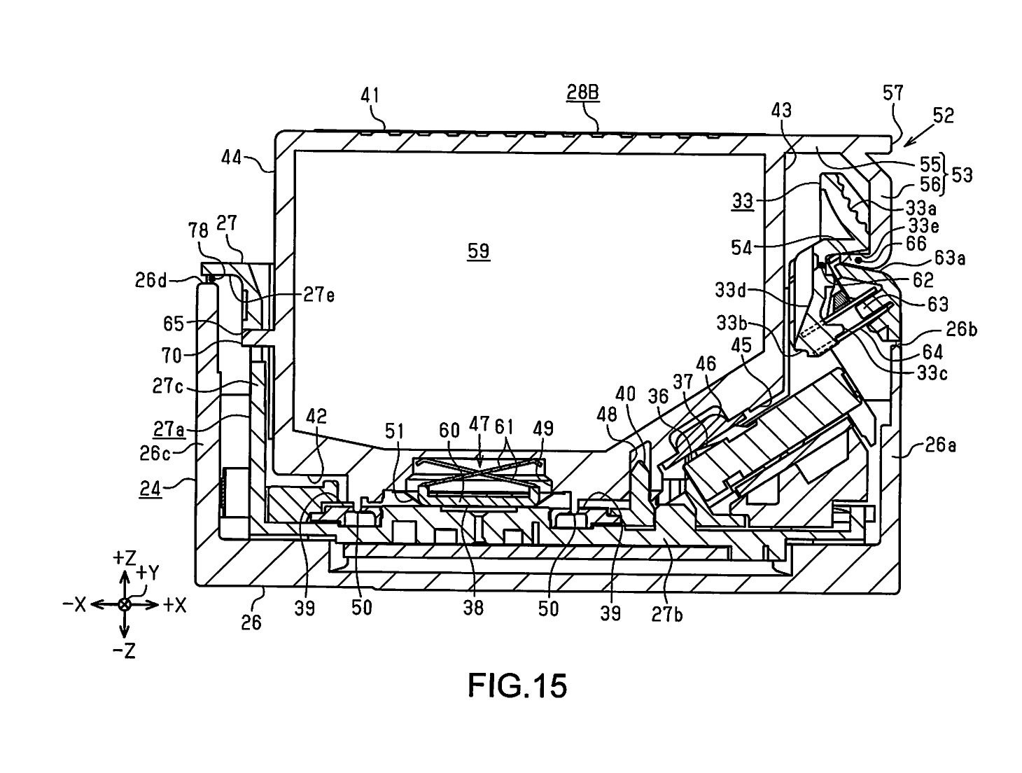

As shown in FIG. 15, in a liquid container 28B of the third embodiment, a −X direction side engaging portion 70 protruding in the −X direction is provided on the outer face of a −X direction side wall portion 44 of the liquid container 28B. A −X direction side engaging portion 70 is a protrusion protruding in the −X direction from the outer face of the −X direction side wall portion 44. In addition, as described in the first embodiment, a −X direction side engagement portion 65 is provided in a side wall 27c on the −X direction side (the left side when the apparatus is viewed from the front) in a mount portion 27. The −X direction side engagement portion 65 is a hole provided in the side wall 27c. The −X direction side engaging portion 70 of the liquid container 28B engages with the −X direction side engagement portion 65 formed in the side wall 27c of the mount portion 27 in a state where the liquid container 28B is mounted on the mount portion 27 (a mounted state). Specifically, in the mounted state, the −X direction side engaging portion 70 engages with the −X direction side engagement portion 65 in a state of abutting against the −X direction side engagement portion 65 from the −Z direction side. In addition, in the mounted state, a hook portion 52 engages with a gap 66 in the Z direction formed between the wall on the +X direction side of a carriage 24 and a rotation lever 33. By engaging the hook portion 52 with the gap 66, and engaging the −X direction side engaging portion 70 with the −X direction side engagement portion 65, vertically upward (the +Z direction) movement of the liquid container 28 is restricted.

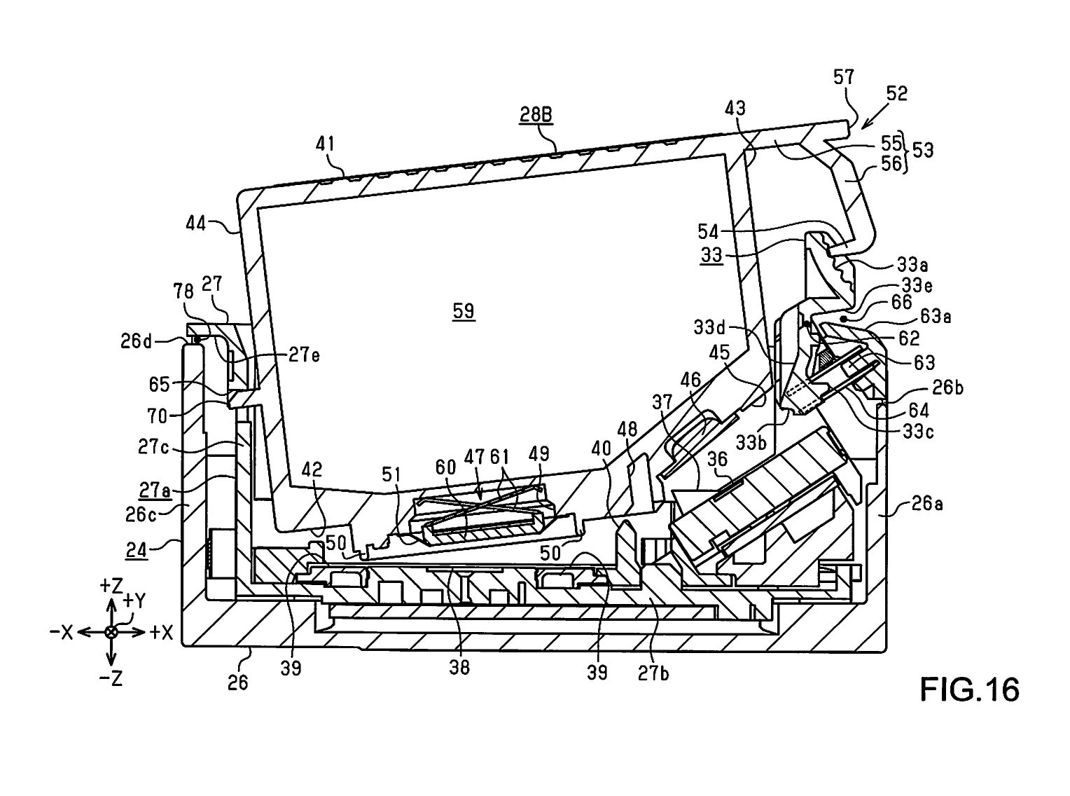

When mounting the liquid container 28B to the mount portion 27 in a state where the liquid container 28B is inclined, the liquid container 28B is moved downward from above the mount portion 27. Specifically, the liquid container 28B is brought into an inclined orientation in which the end portion on the −X direction side of a +Z direction side wall portion 41 is lowered in the −Z direction side, and the liquid container 28B is moved such that the −X direction side engaging portion 70 is inserted into the −X direction side engagement portion 65 of the mount portion 27. As shown in FIG. 16, the −X direction side engaging portion 70 is then inserted into the −X direction side engagement portion 65 of the mount portion 27, and the hook portion 52 on the +X direction side comes into contact with the surface of an operation portion 33a in the rotation lever 33.

Subsequently, when pressing in and rotating the liquid container 28B from that state using, as a fulcrum, the vicinity of a position at which the −X direction side engaging portion 70 is inserted into the −X direction side engagement portion 65 so as to bring the liquid container 28B from the inclined orientation into a horizontal orientation, an arm portion 53 of the hook portion 52 flexuously deforms so as to open, to the outside, a second portion 56 that is positioned on the +X direction side of the rotation lever 33, similarly to the case of the above-described the first embodiment. Subsequently, when further pressing in the liquid container 28B from that state, an engaging portion 54 of the hook portion 52 overrides the lower end of the operation portion 33a in the rotation lever 33 in the −Z direction, engages with the gap 66 in the Z direction formed between the wall on the +X direction side of the carriage 24 and the rotation lever 33, and is brought into the mounted state shown in FIG. 15.

According to the above third embodiment, effects similar to the above-described effects (1) to (4) in the first embodiment can be acquired, and the following effects can be further acquired.

(7) In the liquid container 28B in the mounted state, on the +X direction side, the hook portion 52 engages with an engagement portion (the gap 66), while on the −X direction side, the −X direction side engaging portion 70 engages with the −X direction side engagement portion 65 of the mount portion 27 in a state of abutting against the −X direction side engagement portion 65 from the −Z direction side. Accordingly, movement of the liquid container 28B from the mount portion 27 in the +Z direction can be restricted both in the +X direction and the −X direction. Therefore, the mounted state of the liquid container 28B on the mount portion 27 can be held favorably in a more stable manner.

Note that the above first to third embodiments may be changed as follows.

### Modified Example 1

In the first and third embodiments, the hook portion 52 does not need to cover the entirety of the operation portion 33a in the rotation lever 33, in the mounted state. Accordingly, as the hook portion 52A in the liquid container 28A of the second embodiment, the hook portion 52 may have a configuration in which the opening portion 68 that exposes the operation portion 33a of the rotation lever 33 to the outside is formed therein.

### Modified Example 2

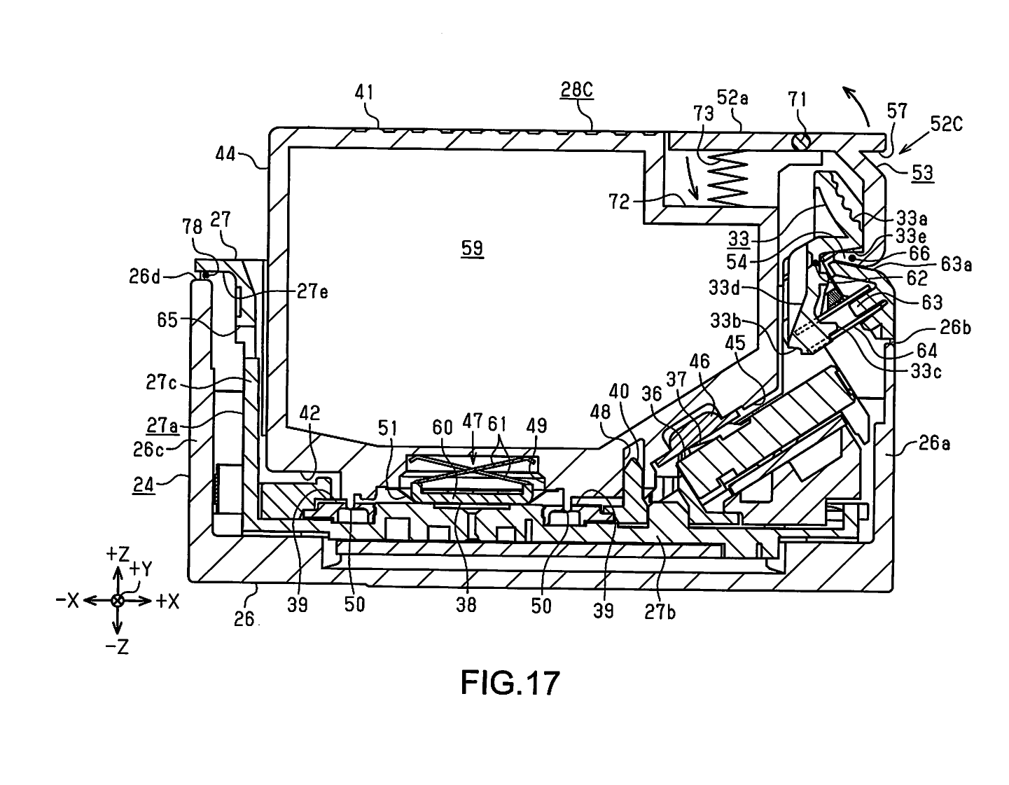

In the first to third embodiments, the hook portions 52 and 52A may be rotatable centered on a shaft along the Y direction. FIG. 17 shows a liquid container 28C provided with such a rotatable hook portion 52C. In the liquid container 28C, the hook portion 52C is provided in an end portion on the +X direction side in the +Z direction side wall portion 41 so as to be rotatable centered on a rotation shaft 71 along the Y direction. The hook portion 52C has the engaging portion 54 that engages with an engagement portion (the gap 66), and an operation portion 52a provided at a position on the opposite side to the engaging portion 54 with the rotation shaft 71 therebetween. A step face 72 is provided below the operation portion 52a. The step face 72 is provided at a position on the −Z direction side relative to the +Z direction side wall portion 41. The step face 72 is a face parallel to the X direction and the Y direction. A biasing member 73 is provided between the step face 72 and the operation portion 52a of the hook portion 52C. The operation portion 52a is biased by the biasing member 73 in a direction in which the engaging portion 54 engages with the engagement portion (the gap 66). By shifting the operation portion 52a against the biasing force of the biasing member 73, the engagement of the hook portion 52C with the engagement portion (the gap 66) is released.

According to this configuration, the engagement of the hook portion 52C with the engagement portion (the gap 66) is supported by the biasing force of the biasing member 73, and becomes more stable. Therefore, the mounted state of the liquid container 28C on the mount portion 27 can be held in a stable manner. In addition, if the operation portion 52a is shifted against the biasing force of the biasing member 73, the engagement of the hook portion 52C with the engagement portion (the gap 66) is released, and thus the operation of mounting/removing the liquid container 28C can be performed easily. Note that a coil spring, a leaf spring, rubber and the like can be used as the biasing member 73. In addition, the biasing member 73 can be constituted by a spiral spring mounted in the periphery of the rotation shaft 71, instead of a spring, rubber or the like provided between the step face 72 and the operation portion 52a.

### Modified Example 3

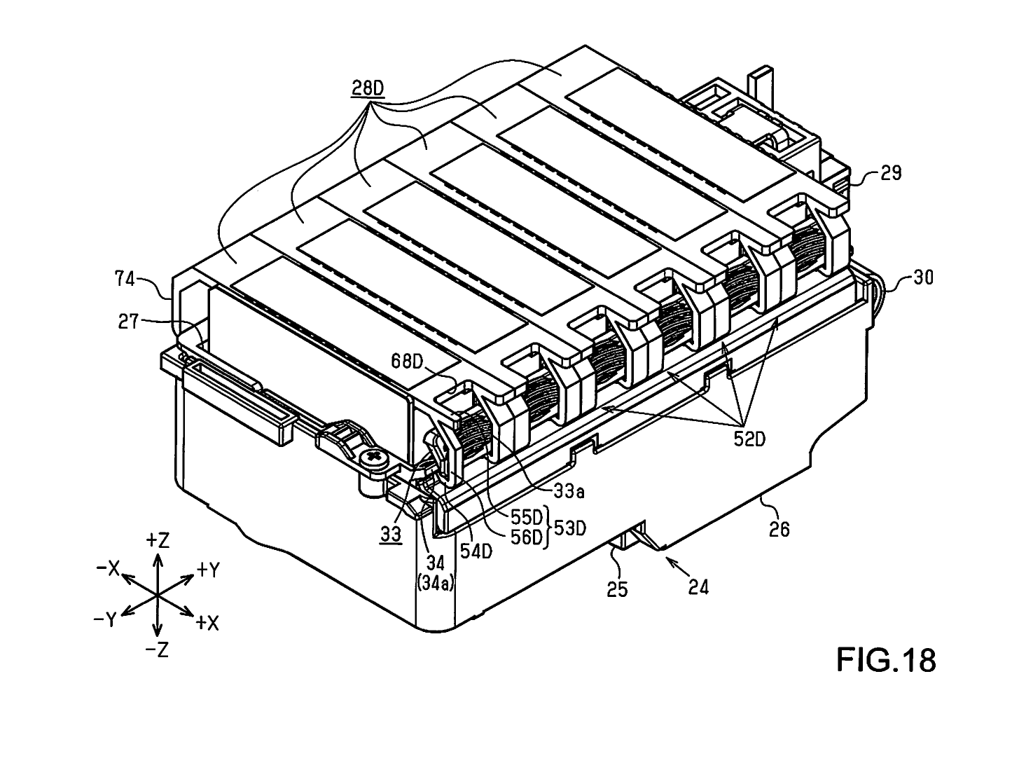

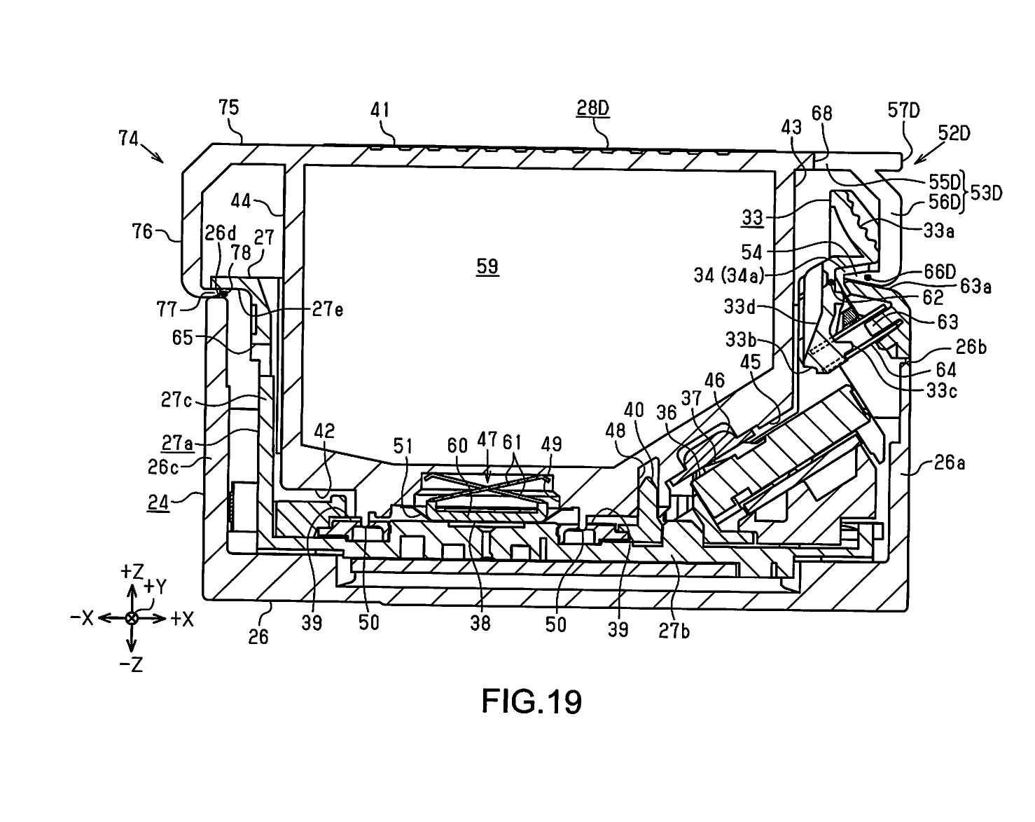

In the first to third embodiments, the hook portions 52 and 52A may be configured to be engaged at a position between the rotation levers 33 adjacent in the Y direction in the mount portion 27. In addition, in the first and second embodiments, hook portions may be provided at two locations, namely, on the +X direction side and on the −X direction side. FIGS. 18 and 19 show a liquid container 28D that has such a configuration.

In the liquid container 28D, a hook portion 52D is provided on an end portion on the +X direction side of a +Z direction side wall portion 41. The hook portion 52D is configured to be engaged at a position between rotation levers 33 of a mount portion 27 adjacent in the Y direction (the depth direction of the apparatus). The hook portion 52D has a configuration similar to that of the hook portion 52A of the second embodiment. In the liquid container 28D, an opening portion 68D is formed in an arm portion 53D of the hook portion 52D, which will be a portion that covers the rotation lever 33 from outside when the liquid container 28D is mounted to the mount portion 27. In the arm portion 53D, the opening portion 68D is formed from a half way in the X direction of a first portion 55D positioned on the +Z direction side of the rotation lever 33 to a portion on the +X direction side, and over the entirety in the Z direction of a second portion 56D that is positioned on the +X direction side of the rotation lever 33. The opening portion 68D exposes an operation portion 33a of the rotation lever 33 to the outside. A handle portion 57D is provided so as to extend in the +X direction from an end portion on the +X direction side of the first portion 55D in the arm portion 53D of the hook portion 52D. The handle portion 57D is used when the user removes the liquid container 28D that is mounted on the mount portion 27, similarly to the handle portion 57 (see FIG. 12) of the first embodiment. An engaging portion 54D provided at the tip end of the hook portion 52D is configured to engage with a gap 66D formed between an upper end portion 34a of a CSIC holder 34 (see FIG. 4) and an upper face 63a of a fixed spring engaging portion 63, at a position between the rotation levers 33. This gap 66D is a recession formed in the outer face on the +X direction side of a carriage 24. Accordingly, in this Modified Example, the outer face on the +X direction side in the carriage 24 serves as an engagement portion.

According to this configuration, for example, even if the rotation lever 33 has a defect, the liquid container 28D can be mounted to the mount portion 27 without being affected by the defect.

In addition, the liquid container 28D has a second hook portion 74. The second hook portion 74 is provided on the end portion on the −X direction side of the +Z direction side wall portion 41. The second hook portion 74 has a first portion 75 extending in the −X direction from the end portion on the −X direction side of the +Z direction side wall portion 41, and a second portion 76 extending in the −Z direction from the tip end of the first portion 75. A nail-shaped second engaging portion 77 is provided at the tip end of the second portion 76. The second engaging portion 77 is engaged between a lower face 27e of an upper portion of an inner wall member 27a and an upper end 26d of a wall 26c on the −X direction side of a case 26, that is, a gap 78 (a second engagement portion) in the Z direction formed in the wall on the −X direction side of the carriage 24, so as to restrict vertically upward (the +Z direction) movement of the liquid container 28D.

According to this configuration, on the +X direction side, the first hook portion 52D engages with an engagement portion (the gap 66D), while on the −X direction side, the second hook portion 74 engages with an engagement portion (the gap 78). Accordingly, movement of the liquid container 28D from the mount portion 27 in the +Z direction can be restricted both in the +X direction and the −X direction. Therefore, the mounted state of the liquid container 28D on the mount portion 27 can be maintained favorably in a more stable manner.

### Modified Example 4

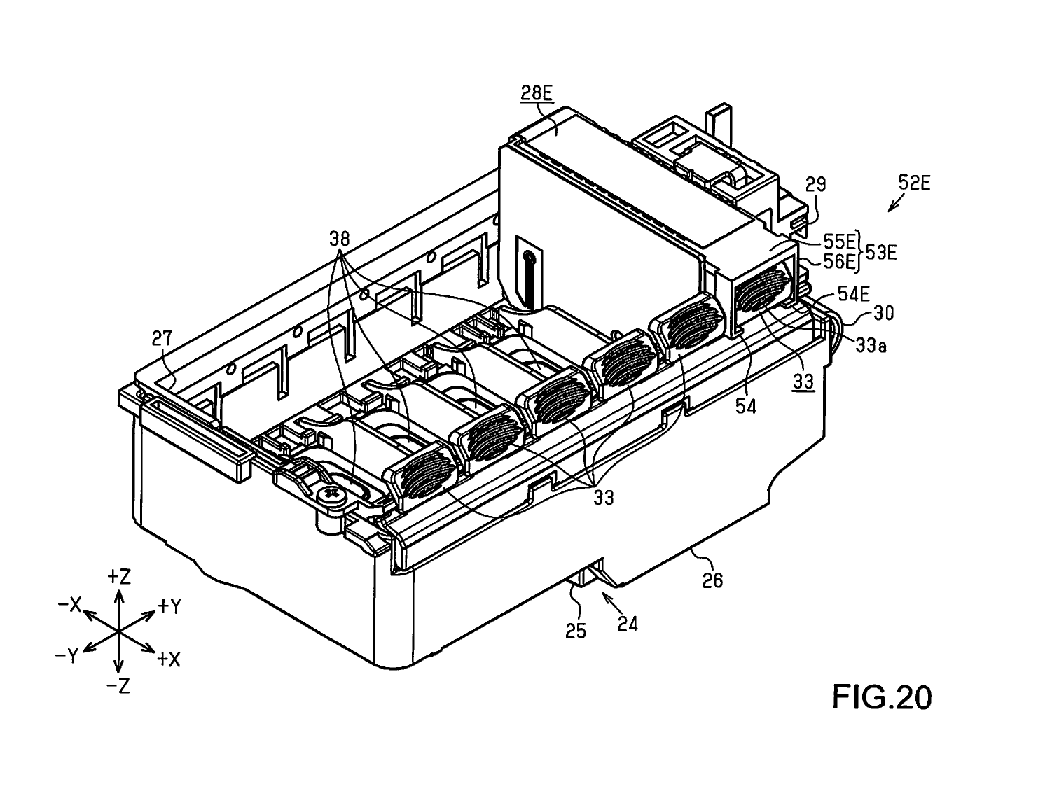

In the first to third embodiments, the hook portions 52 and 52A may be configured to extend in the −Z direction while passing between the rotation levers 33 adjacent in the Y direction in the mount portion 27, then curve in the Y direction, and engage with an engagement portion (the gap 66 or the like). FIGS. 20 to 22 show a liquid container 28E provided with the hook portion 52E as described above. The liquid container 28E has a hook portion 52E. An arm portion 53E of the hook portion 52E has a first portion 55E and a second portion 56E. The first portion 55E is positioned on the +Z direction side of the rotation lever 33. The second portion 56E extends in the −Z direction while passing between the rotation levers 33 adjacent in the Y direction in the mount portion 27, and then curves in the Y direction. An engaging portion 54E provided at the tip end of the hook portion 52E is configured to engage with a gap 66 (engagement portion) in the Z direction formed between the wall on the +X direction side of a carriage 24 and the rotation lever 33. The surface on the +X direction side of an operation portion 33a of the rotation lever 33 is not covered by the hook portion 52E. In other words, the operation portion 33a of the rotation lever 33 is in a state of being exposed to the outside. Additionally, the hook portion 52E is not positioned on the +X direction side relative to the operation portion 33a of the rotation lever 33. Therefore, the size of the hook portion 52E can be reduced in the +X direction.

### Modified Example 5

(i) In the above first to third embodiments, and Modified Example 2, a position at which the engaging portion 54 and 54A of the hook portions 52, 52A and 52C are engaged is not limited to the above-described gap 66. For example, the hook portions 52 and 52A may be configured to be engaged with a portion of the outer face on the +X direction side of the carriage (moving body) 24 (for example, an engagement portion formed in a step-like shape or an indented shape, on the outer face of the +X direction side wall portion of the carriage 24, and the like, in addition to the gap 66D described in Modified Example 3). Alternatively, the hook portions 52 and 52A may be configured to engage with a portion of the outer face on the +X direction side of the rotation lever 33 (e.g., an engagement portion formed in a nail-like shape on the surface of the operation portion 33a of the rotation lever 33).

(ii) In the first to third embodiments, the hook portions 52 and 52A may be configured to be provided such that the arm portion 53 thereof extends in the +Z direction and the +X direction from a portion of the upper face of the +Z direction side wall portion 41 of the liquid container 28, then extends in the −Z direction, and covers at least a portion of the operation portion 33a of the rotation lever 33.

(iii) In the first to third embodiments, the hook portions 52 and 52A may be configured to be provided such that the arm portions 53 and 53A thereof extend in the +X direction and the −Z direction from a portion of the side wall of the +X direction side wall portion 43 of the liquid containers 28 and 28A, and the arm portions 53 and 53A cover at least a portion of the operation portion 33a of the rotation lever 33.

### Fourth Embodiment

Next, a fourth embodiment will be described with a focus on differences from the first embodiment.

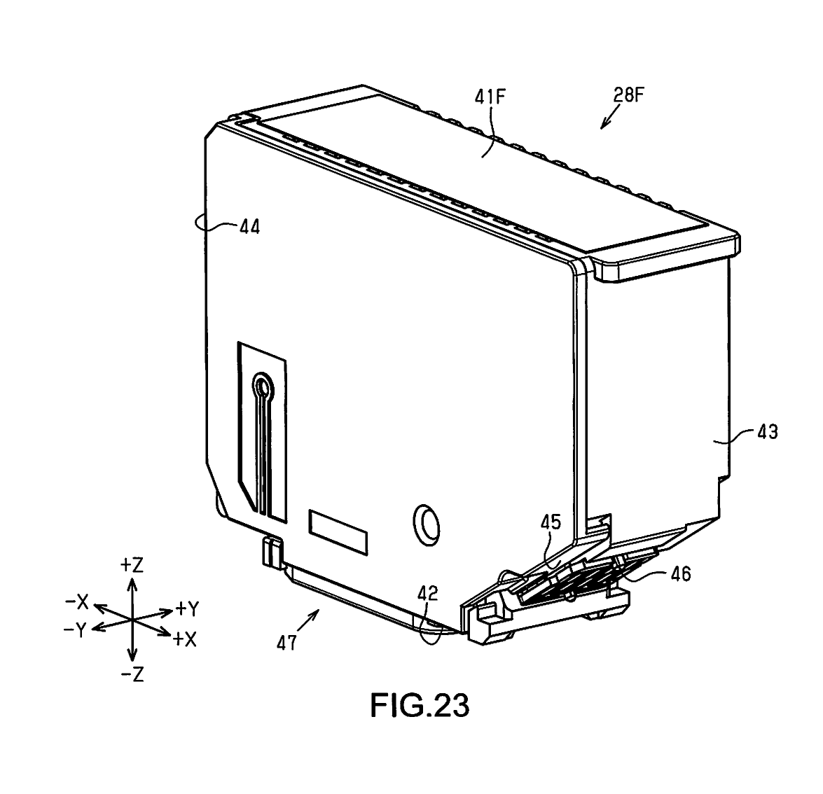

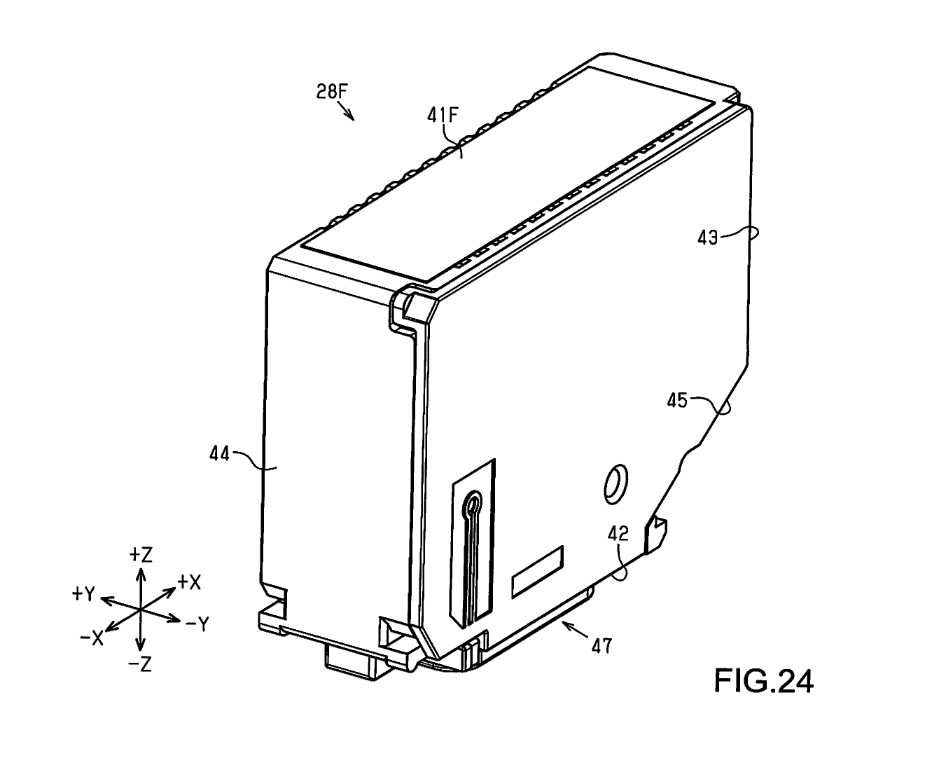

As shown in FIGS. 23 and 24, a liquid container 28F that is mounted to/removed from a mount portion 27 in the fourth embodiment is acquired by removing the hook portion 52 from the liquid container 28 shown in FIGS. 5 and 6 in the first embodiment. When such a liquid container 28F is mounted to the mount portion 27, the following configuration is adopted in this embodiment in order to restrict movement of the liquid container 28F from the mount portion 27 in the +Z direction.

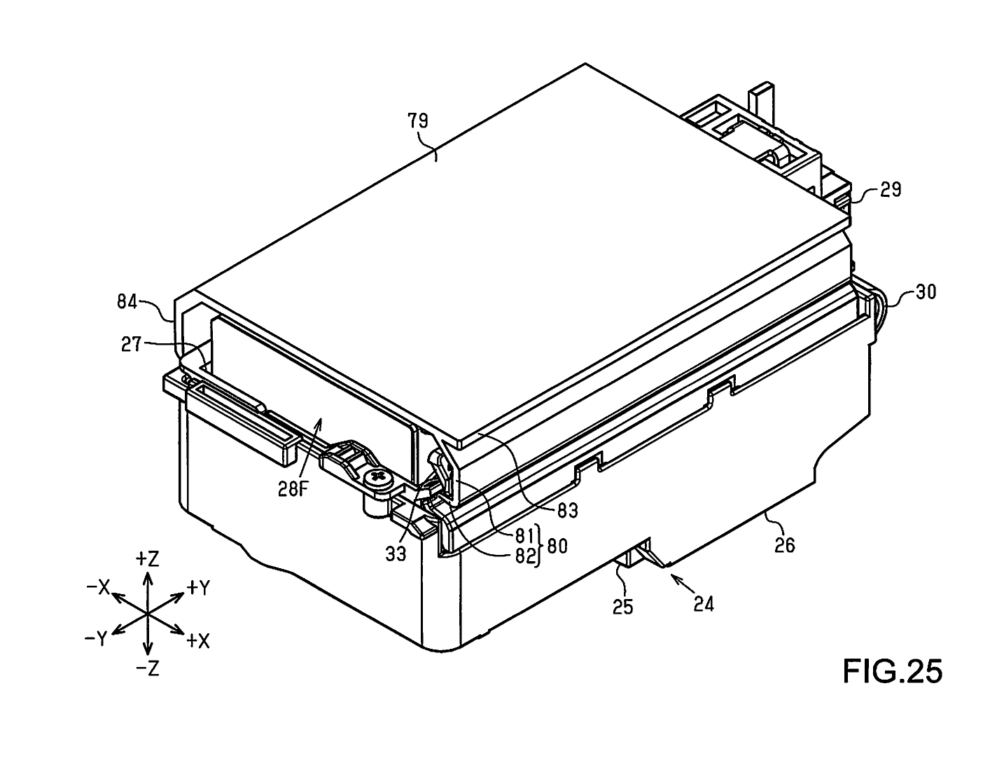

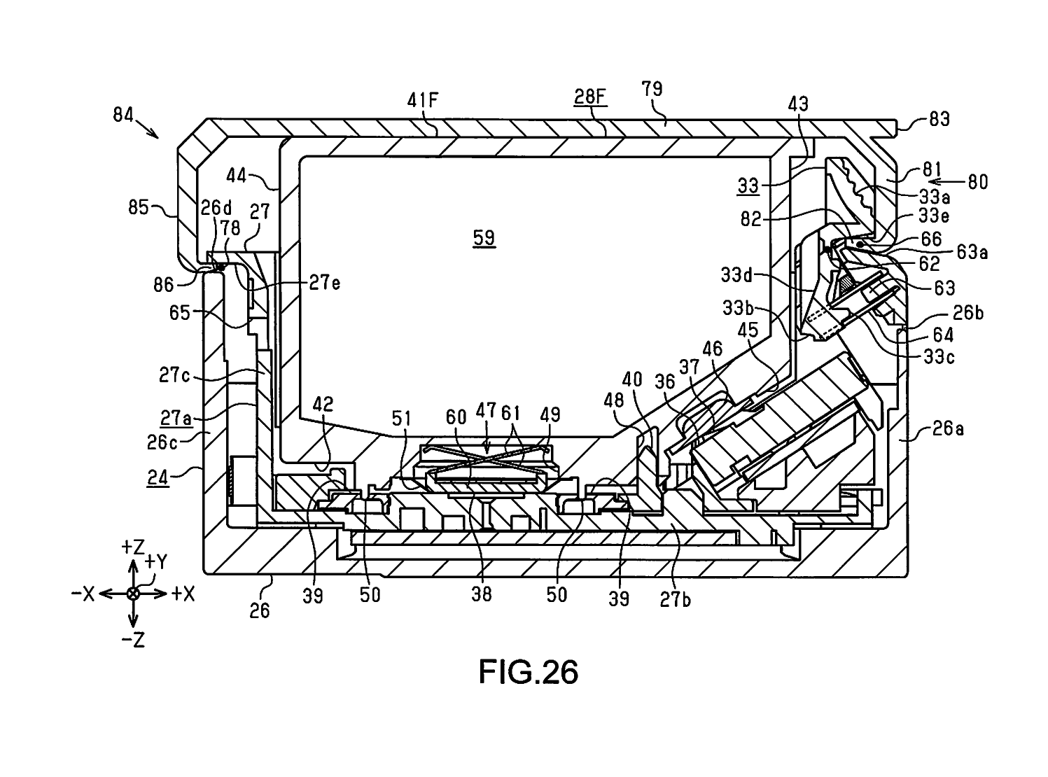

As shown in FIGS. 25 and 26, in this embodiment, a cover 79 that covers a +Z direction side wall portion 41F in the liquid container 28F arranged on the mount portion 27 is attached to the mount portion 27 so as to be in contact with the +Z direction side wall portion 41F. This cover 79 is provided with a hook portion 80 (a first hook portion 80) that has an engagement function similar to the hook portion 52 provided in the liquid container 28 of the first embodiment. The hook portion 80 is provided in the end portion on the +X direction side of the cover 79. The hook portion 80 is positioned above the rotation lever 33 in a state where the liquid container 28F is mounted on the mount portion 27 (a mounted state). In addition, the hook portion 80 has an arm portion 81 that is positioned on the +Z direction side and the +X direction side of the rotation lever 33, and covers an operation portion 33a, and a nail-shaped engaging portion 82 (a first engaging portion 82) provided at the tip end of the arm portion 81. In the mounted state, the engaging portion 82 engages with a gap 66 (an engagement portion) in the Z direction formed between the wall on the +X direction side of a carriage 24 and the rotation lever 33, so as to restrict vertically upward (the +Z direction) movement of the liquid container 28F. A handle portion 83 is provided on the hook portion 80. The handle portion 83 is used when the user removes the cover 79 mounted on the mount portion 27. Accordingly, the user can remove the cover 79 from the mount portion 27 by hooking his or her finger tip on the handle portion 83. The handle portion 83 extends in the +X direction from the base end portion in the arm portion 81 of the hook portion 80.

In addition, the cover 79 is provided with a second hook portion 84 that has an engagement function similar to that of the second hook portion 74 provided on the −X direction side in the liquid container 28D of Modified Example 3. The second hook portion 84 is provided in the end portion on the −X direction side. The second hook portion 84 has an arm portion 85 that extends in the −Z direction from the end portion on the −X direction side of the cover 79 and a nail-shaped second engaging portion 86 provided at the tip end of the arm portion 85. The second engaging portion 86 is engaged between a lower face 27e of an upper portion of an inner wall member 27a and an upper end 26d of a wall 26c on the −X direction side of a case 26, that is, a gap 78 (an engagement portion) in the Z direction formed in the wall on the −X direction side of the carriage 24, so as to restrict vertically upward (the +Z direction) movement of the liquid container 28F.

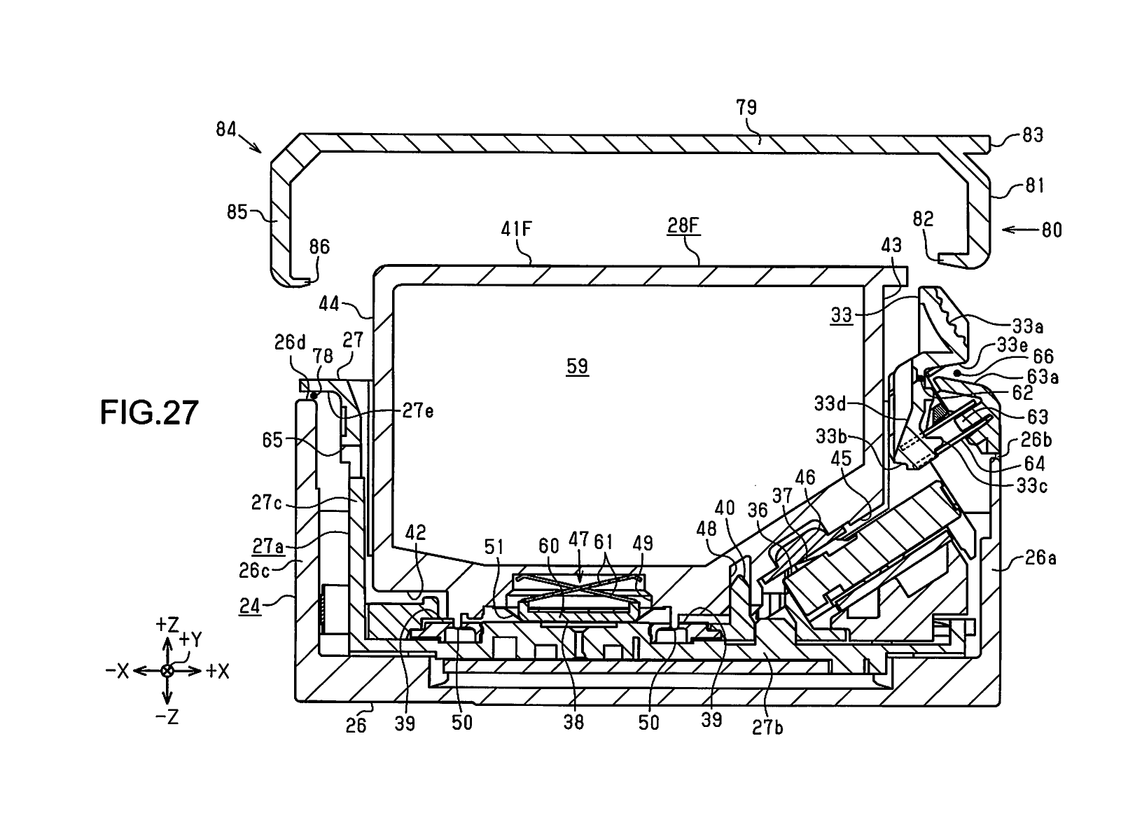

As shown in FIG. 27, the cover 79 can be completely removed from the carriage 24. When mounting the liquid container 28F to the mount portion 27, first, the liquid container 28F is arranged in the mount portion 27. After that, the cover 79 is laid over the +Z direction side wall portion 41 of the liquid container 28F so as to cover the +Z direction side wall portion 41F, and is mounted to the carriage 24.

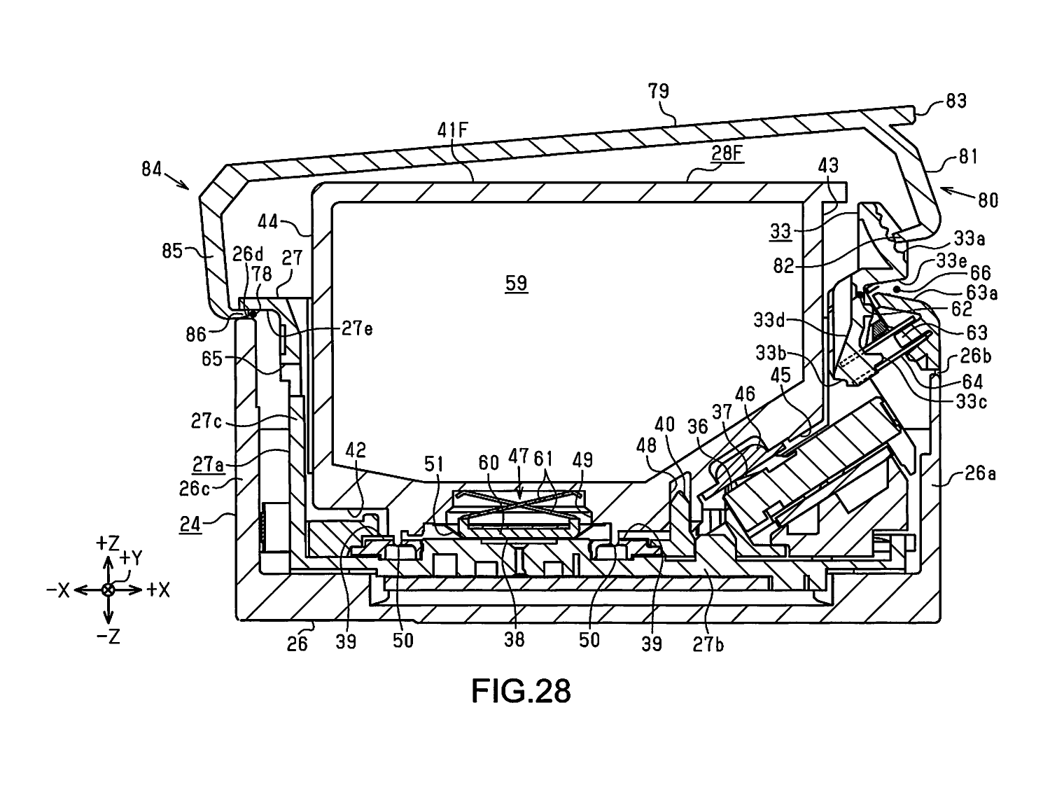

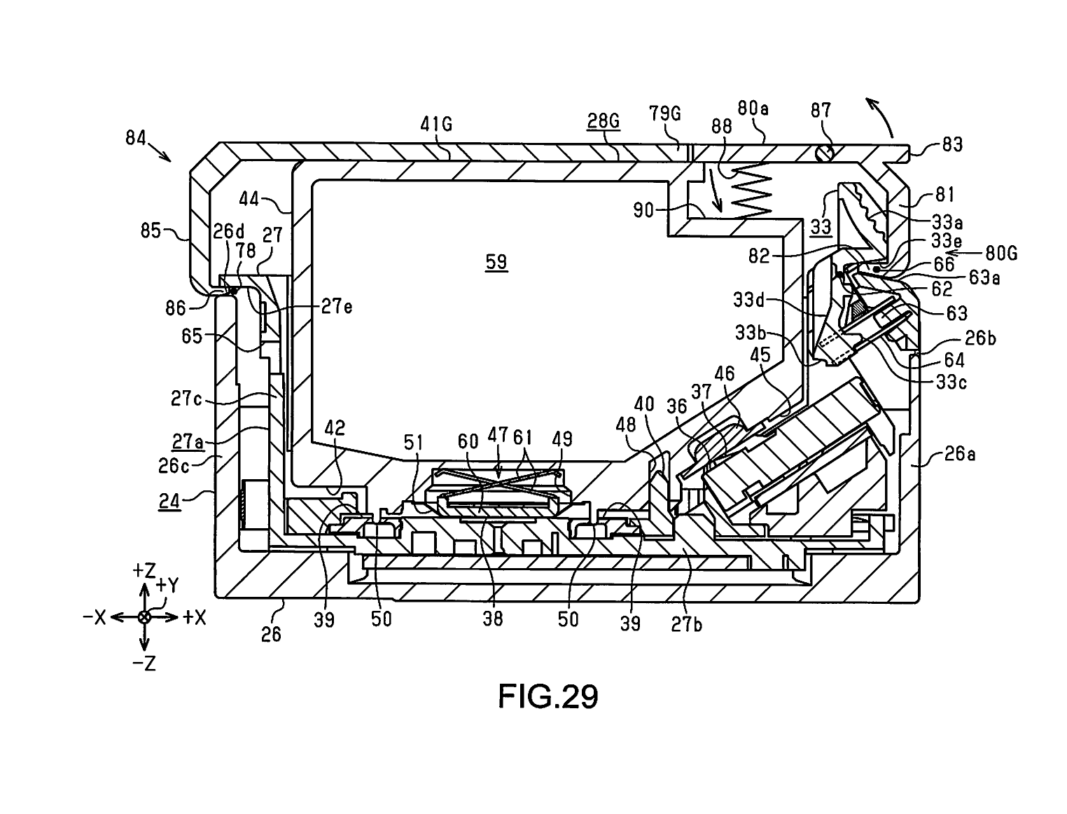

The cover 79 is mounted to the carriage 24 by respectively engaging the first hook portion 80 and the second hook portion 84 with the gap 66 and the gap 78. As long as the arm portion 81 of the first hook portion 80 and the arm portion 85 of the second hook portion 84 can deform flexurally, either the first hook portion 80 or the second hook portion 84 may be engaged first. As an example, FIG. 28 shows a procedure for first engaging the second hook portion 84 with the gap 78, and after that, engaging the hook portion 80 with the gap 66 while rotating and moving the cover 79 as shown in FIG. 29.

When removing the liquid container 28F from the mount portion 27, the engagement between the first hook portion 80 and the gap 66, and the engagement between the second hook portion 84 and the gap 78 are released, and the cover 79 is removed from the carriage 24. After that, the liquid container 28F is removed from the mount portion 27.

According to the above fourth embodiment, the following effects can be acquired.

(8) When mounting the liquid container 28F to the mount portion 27, it suffices to respectively engage the hook portions 80 and 84 of the cover 79 that covers the liquid container 28F with the gaps 66 and 78 (engagement portions) after arranging the liquid container 28F in the mount portion 27. When removing the liquid container 28F, it suffices for the liquid container 28F to be removed from the mount portion 27 after releasing the engagement of the hook portions 80 and 84 with the gaps 66 and 78 (the engagement portions). Therefore, the operation of mounting/removing the liquid container 28F to/from the mount portion 27 can be performed easily.

(9) In addition, in a state where the hook portions 80 and 84 of the cover 79 are in engagement with the gaps 66 and 78 (the engagement portions), movement of the liquid container 28F in the +Z direction is restricted by the cover 79, and thus the mounted state of the liquid container 28F on the mount portion 27 can be held favorably. Therefore, the connection state between the liquid supplying portion 47 of the liquid container 28F mounted on the mount portion 27 and the liquid introduction portion 38 of the mount portion 27, and the connection state between the circuit substrate 46 on the liquid container 28F side and the electrical connection portion 36 on the mount portion 27 side can be held favorably.

(10) In addition, in a state where the liquid container 28F is mounted on the mount portion 27 (the mounted state), the operation portion 33a of the rotation lever 33 is covered by the hook portion 80 of the cover 79 from the +Z direction side and the +X direction side. Therefore, it is possible to suppress application of an unexpected external force to the operation portion 33a, and to reduce a risk that and the liquid container 28F unexpectedly comes off the mount portion 27 due to the rotation lever 33 being moved in an unnecessary manner.

(11) In addition, the cover 79 is fixed to the carriage 24 both on the +X direction side and on the −X direction side. Specifically, the first hook portion 80 engages with an engagement portion (the gap 66) on the +X direction side, while the second hook portion 84 engages with an engagement portion (the gap 78) on the −X direction side. Accordingly, movement of the liquid container 28F from the mount portion 27 in the +Z direction can be restricted both in the +X direction and the −X direction. Therefore, the mounted state of the liquid container 28F on the mount portion 27 can be maintained favorably in a more stable manner.

Note that the above fourth embodiment may be changed as follows.

### Modified Example 6

In the fourth embodiment, the hook portion 80 of the cover 79 may be rotatable centered on a shaft along the Y direction. FIG. 29 shows a configuration in which a cover 79G provided with a rotatable hook portion 80G is used. The first hook portion 80G is provided in an end portion on the +X direction side of the cover 79G so as to be rotatable centered on a rotation shaft 87 along the Y direction. The hook portion 80G has the engaging portion 82 that engages with an engagement portion (the gap 66), and an operation portion 80a provided at a position on the opposite side to the engaging portion 82 with the rotation shaft 87 therebetween.

On the other hand, a step face 90 is provided on a liquid container 28G. In the mounted state, the step face 90 is provided at a position below the operation portion 80a of the hook portion 80G provided on the cover 79G. The step face 90 is provided at a position on the −Z direction side relative to a +Z direction side wall portion 41G of the liquid container 28G. The step face 90 is a face that is flat in the X direction and the Y direction. A biasing member 88 is provided between the step face 90 and the operation portion 80a of the hook portion 80. The biasing member 88 is preferably fixed over the step face 90 of the liquid container 28G or the lower face of the operation portion 80a of the cover 79G. The engaging portion 82 of the hook portion 80G is biased by the biasing member 88 in a direction in which the engaging portion 82 engages with an engagement portion (the gap 66). By shifting the operation portion 80a against the biasing force of the biasing member 88, the engagement state of the hook portion 80G with the engagement portion (the gap 66) is released.

According to this configuration, the engagement of the hook portion 80G with the engagement portion (the gap 66) is supported by the biasing force of the biasing member 88, and becomes more stable. Therefore, the mounted state of the liquid container 28G on the mount portion 27 can be held in a stable manner. In addition, if the operation portion 80a is shifted against the biasing force of the biasing member 88, the engagement state of the hook portion 80G with the engagement portion (the gap 66) is released, and thus the operation of mounting/removing the liquid container 28G can be performed easily. Note that, for example, a coil spring, a leaf spring, rubber or the like can be used for the biasing member 88. In addition, the biasing member 88 can also be constituted by a spiral spring mounted in the periphery of the rotation shaft 87, instead of a spring, rubber or the like provided between the step face 90 and the operation portion 80a.

### Modified Example 7

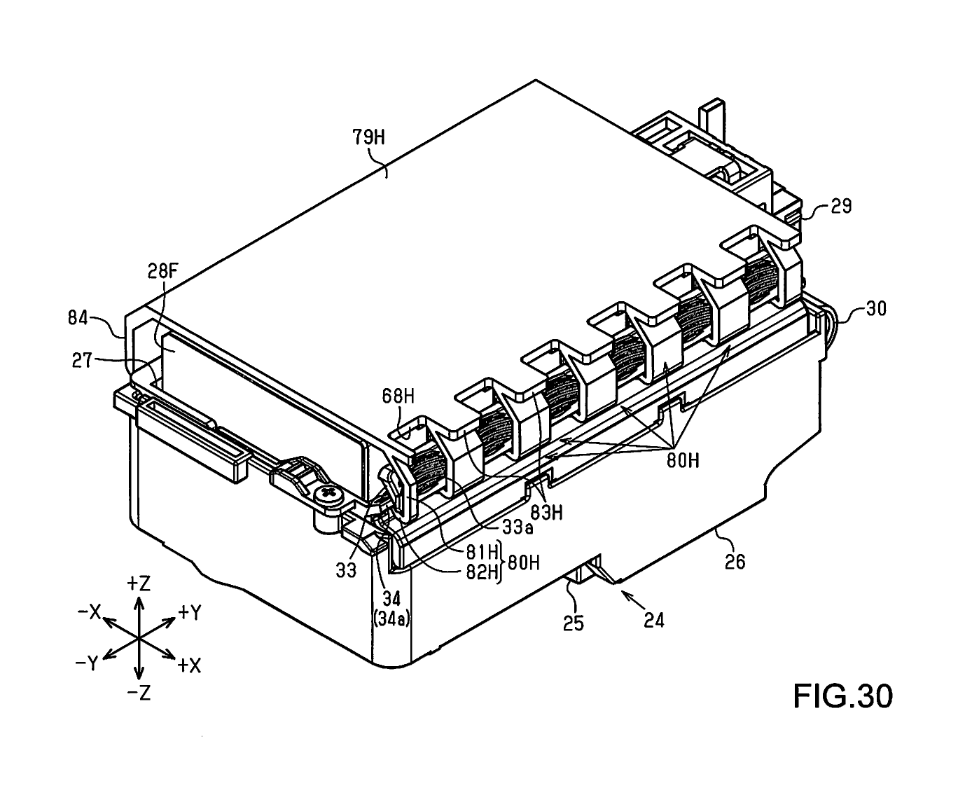

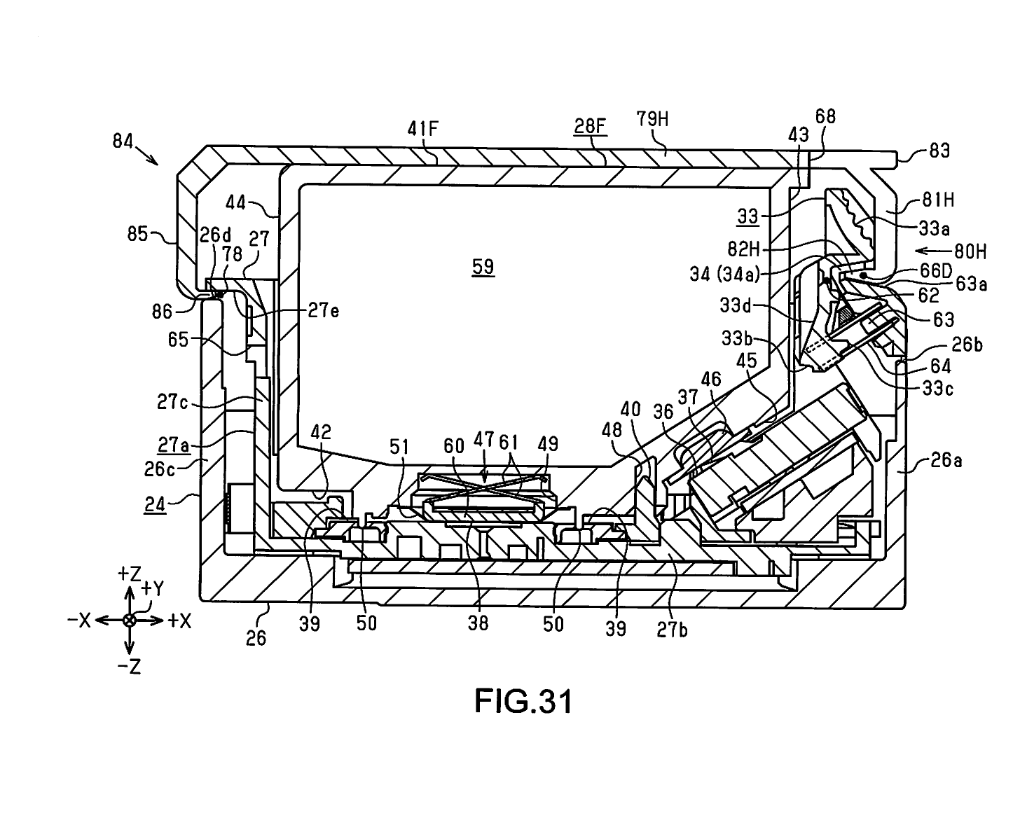

In the fourth embodiment, the hook portion 80 may be configured to be engaged at a position between the rotation levers 33 adjacent in the Y direction in the mount portion 27. FIGS. 30 and 31 show a configuration in which a cover 79H provided with such a hook portion 80H is used. The hook portion 80H of the cover 79H is configured to be engaged at a position between the rotation levers 33 adjacent in the Y direction in the mount portion 27. The hook portion 80H has a configuration similar to that of the hook portion 52D of Modified Example 3. In the mounted state, an opening portion 68H is formed in an arm portion 81H of the hook portion 80H, which will be a portion that covers the rotation lever 33 from outside. In the arm portion 81H, the opening portion 68H is formed from a half way of in the X direction of a first portion that is positioned on the +Z direction side of the rotation lever 33 to a portion on the +X direction side, and over the entirety in the Z direction of a second portion that is positioned on the +X direction side of the rotation lever 33. The opening portion 68H exposes the operation portion 33a of the rotation lever 33 to the outside. A handle portion 83H is provided so as to extend in the +X direction from an end portion on the +X direction side of the first portion in the arm portion 81H of the hook portion 80H. The handle portion 83H is used when the user removes the liquid container 28F that is mounted on the mount portion 27 similarly to the handle portion 57 (see FIG. 12) of the first embodiment. An engaging portion 82H provided at the tip end of the hook portion 80H is configured to engage with the gap 66D formed between the upper end portion 34a of the CSIC holder 34 (see FIG. 4) and the upper face 63a of the fixed spring engaging portion 63, at a position between the rotation levers 33. This gap 66D is a recession formed in the outer face on the +X direction side in the carriage 24. Accordingly, in this Modified Example, the outer face on the +X direction side of the carriage 24 serves as an engagement portion.

According to this configuration, for example, even if the rotation lever 33 has a defect, the cover 79H can be mounted, and the liquid container 28F can be mounted to the mount portion 27, without being affected by the defect.

### Modified Example 8

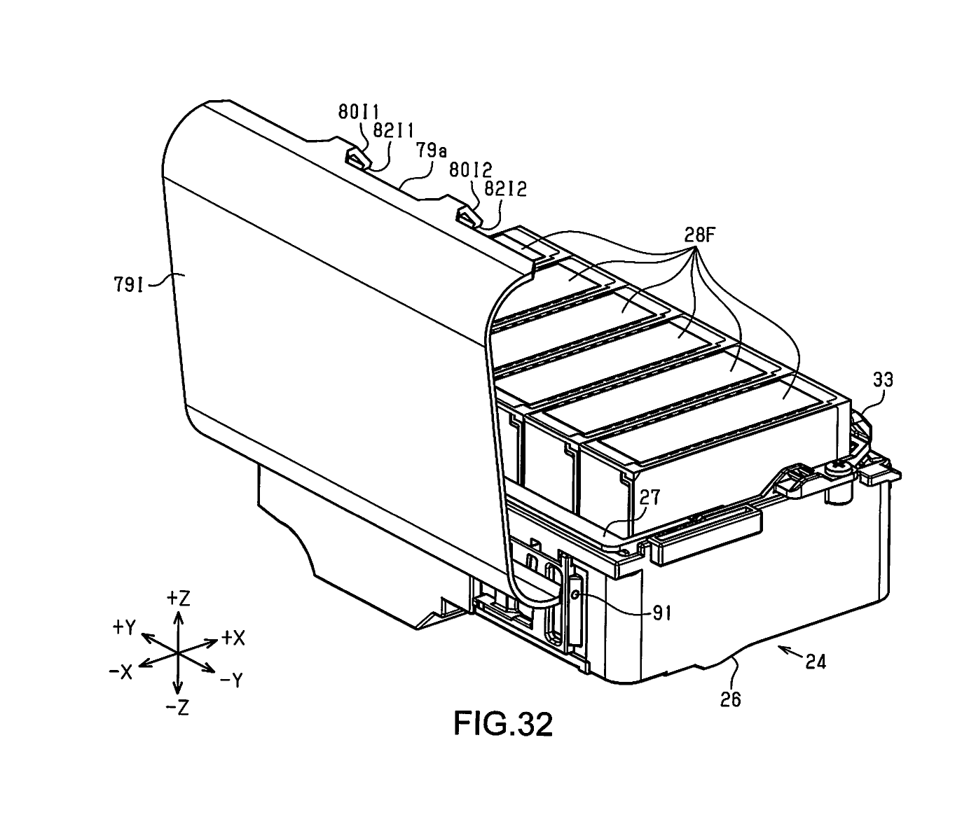

In the fourth embodiment and Modified Examples 6 and 7, the end portions on the −X direction side of the covers 79, 79G and 79H may be supported on the outer face on the −X direction side in the carriage 24, centered on a shaft along the Y direction. In addition, the numbers and shapes of the hook portions 80, 80G, 80H and 84 of the covers 79, 79G and 79H are not limited to those shown in FIGS. 25 and 30. The numbers and shapes of the hook portion 80, etc. of the cover 79, etc. can be changed in a range in which movement of the liquid container 28F, etc. from the mount portion 27 in the +Z direction can be restricted when the cover 79, etc. is mounted on the carriage 24. FIG. 32 shows an example of a configuration in which such modification is added. In Modified Example 8 shown in FIG. 32, the end portion on the −X direction side of a cover 79I is supported by the outer face on the −X direction side of the carriage (moving body) 24. The cover 79I is rotatably supported centered on a rotation shaft 91 that lies along the Y direction. According to this configuration, in a state where the cover 79I is attached to the carriage (moving body) 24, the cover 79I can be shifted between a closed position at which the mount portion 27 is covered and an open position at which the mount portion 27 is opened. Therefore, a risk that the cover 79I is lost can be reduced. In addition, a hook portion 8011 that has an engaging portion 8211 and a hook portion 8012 that has an engaging portion 8212 are provided in an end portion on the +X direction side of the cover 79I. The engaging portions 8211 and 8212 of the hook portions 8011 and 8012 engage with the above-described gap 66 (see FIG. 26). An edge portion 79a between the two hook portions 8011 and 8212 can be used as a handle portion on which the user places his or her hand when opening/closing the cover 79I.

### Modified Example 9

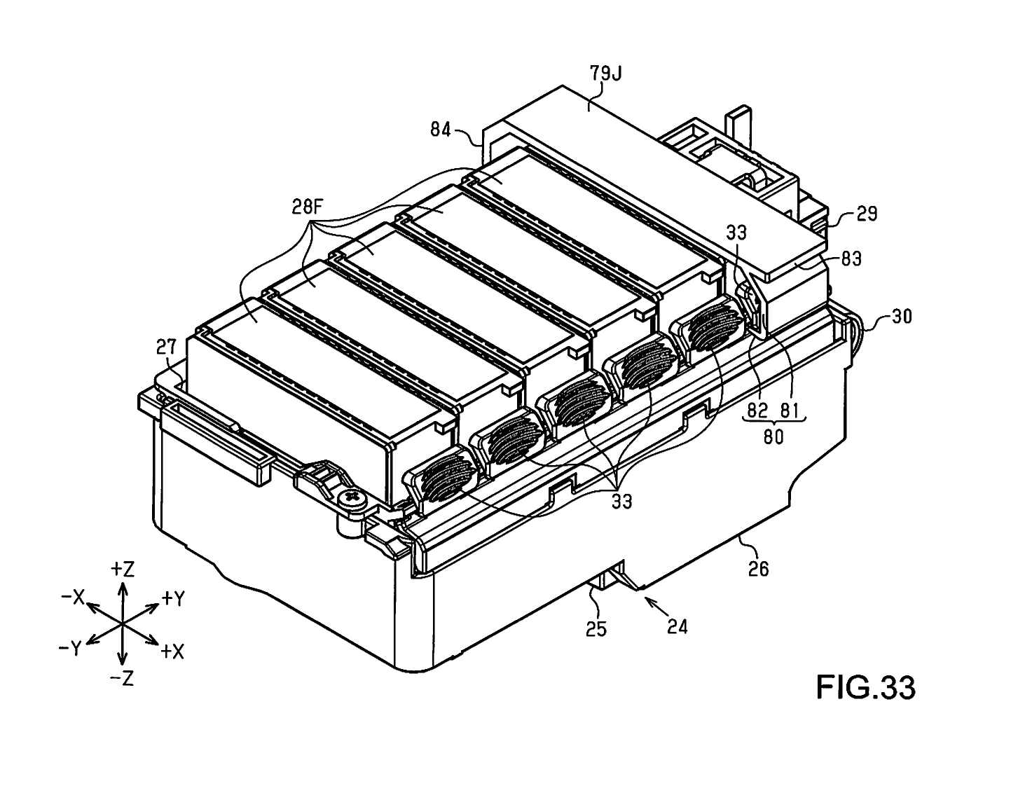

In the fourth embodiment and Modified Examples 6 to 8, the size of the cover 79, 79G, 79H or 79I may be a size for covering one liquid container 28F or 28G (or more), instead of a size for collectively covering all of the liquid containers 28F and 28G mounted on the mount portion 27. As an example of a configuration in which such a cover is used, FIG. 33 shows a configuration in which the cover 79 of the fourth embodiment is changed to a cover 79J whose size is a size for individually covering one liquid container 28F.

According to this configuration, out of a plurality of the liquid containers 28F that are mounted on the mount portion 27 in a state where the upper portions of the liquid containers 28F is covered by the covers 79J, it is possible to remove only the cover 79J that covers the upper portion of the liquid container 28F that needs to be removed from the mount portion 27. Therefore, it is possible to suppress unintended contact with the other liquid containers 28F that do not need to be removed.

### Modified Example 10

(i) In the fourth embodiment and Modified Examples 8 and 9, the hook portions 80, 8011 and 8012 of the covers 79, 79I and 79J may be configured to extend in the −Z direction while passing between the rotation levers 33 adjacent in the Y direction in the mount portion 27, then curve in the Y direction, and engage with an engagement portion (the gap 66 or the like). Accordingly, the hook portion 80, etc. such as the cover 79 may have a shape similar to the shape of the hook portion 52E described in Modified Example 4. If the hook portion 80, etc. such as the cover 79 has such a configuration, the size of the hook portion 80 and the like can be reduced in the +X direction similarly to Modified Example 4.

(ii) In the fourth embodiment, Modified Examples 6, 8, and 9, a position at which the engaging portion (first engaging portion) 82 of the hook portions (first hook portions) 80, 80G, 8011 and 8012 is engaged is not limited to above-described gap 66. For example, the hook portions 80 and 80G may be configured to engage with a portion of the outer face on the +X direction side of the carriage (moving body) 24 (for example, the gap 66D described in Modified Example 7, an engagement portion formed in a step-like shape or an indented shape on the outer face of the +X direction side wall portion of the carriage 24, or the like).

Similarly, in the fourth embodiment and Modified Example 6, a position at which the engaging portion (second engaging portion) 86 of the hook portion (second hook portion) 84 is engaged is not limited to the above-described gap 78 as well. For example, the hook portion 84 may be configured to engage with a portion (an engagement portion formed in a step-like shape or an indented shape on the outer face of the −X direction side wall portion of the carriage 24, or the like) of the outer face on the −X direction side of the carriage (moving body) 24.

(iii) In the fourth embodiment and Modified Examples 6 to 8, and 9 (i) and (ii), the cover 79 does not need to cover the entirety of the +Z direction side wall portions 41F and 41G of the liquid containers 28F and 28G. Accordingly, when the cover 79 is mounted to the carriage 24, it suffices for the cover 79 to cover the +Z direction side wall portions 41F and 41G of the liquid containers 28F and 28G to an extent where movement in the +Z direction of the liquid containers 28F and 28G arranged on the mount portion 27 can be restricted.

(iv) In the fourth embodiment and Modified Examples 6 to 8, and 9 (i) to (iii), the liquid containers 28F and 28G may have a +X direction side engaging portion protruding in the +X direction on the outer face of the +X direction side wall portion 43, as the liquid container 28A (see FIG. 14) in the second embodiment. In addition, the liquid containers 28F and 28G may have a −X direction side engaging portion protruding in the −X direction on the outer face of the −X direction side wall portion 44, as the liquid container 28B (see FIG. 15) in the third embodiment. According to this configuration, movement of a liquid container in the mounted state is restricted in the +Z direction by the cover 79 (79G, 79H, and 79I), and movement of the liquid container in the +Z direction is also restricted by the +X direction side engaging portion and the −X direction side engaging portion. Therefore, even if an unintended external force is applied to the cover 79 (79G, 79H or 79I), and the cover 79 or the like comes off the carriage 24, it is possible to reduce a risk that the liquid container 28F (28G) is inadvertently removed from the mount portion 27, and the mounted state of the liquid container 28F (28G) on the mount portion 27 can be held more favorably.

### Fifth Embodiment

Next, a fifth embodiment will be described with a focus on differences from the first embodiment.

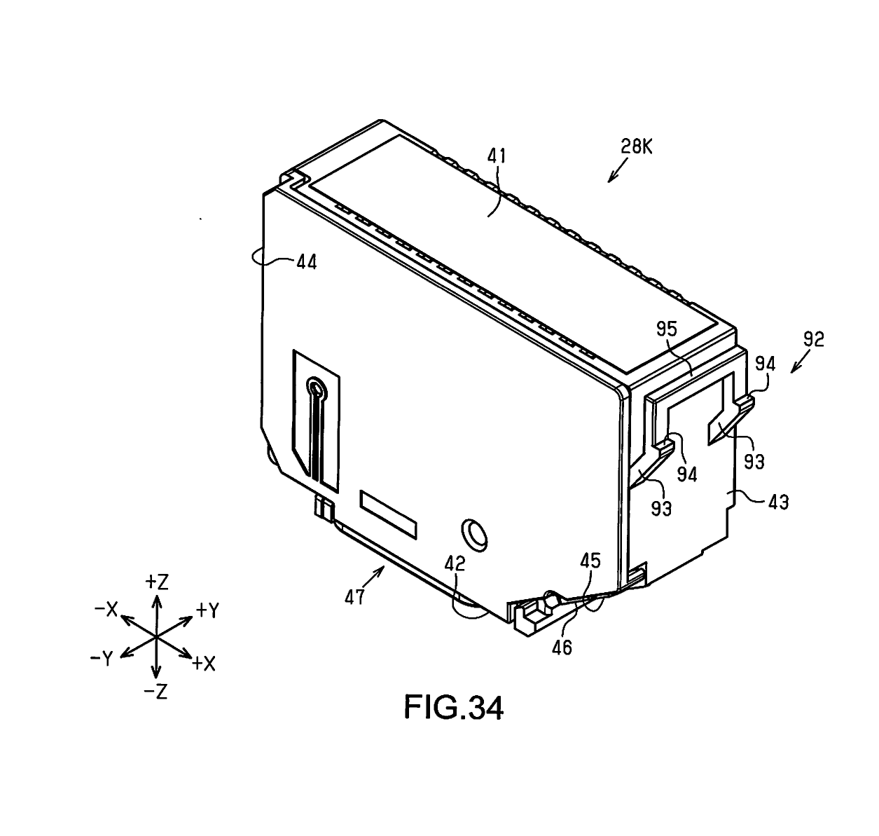

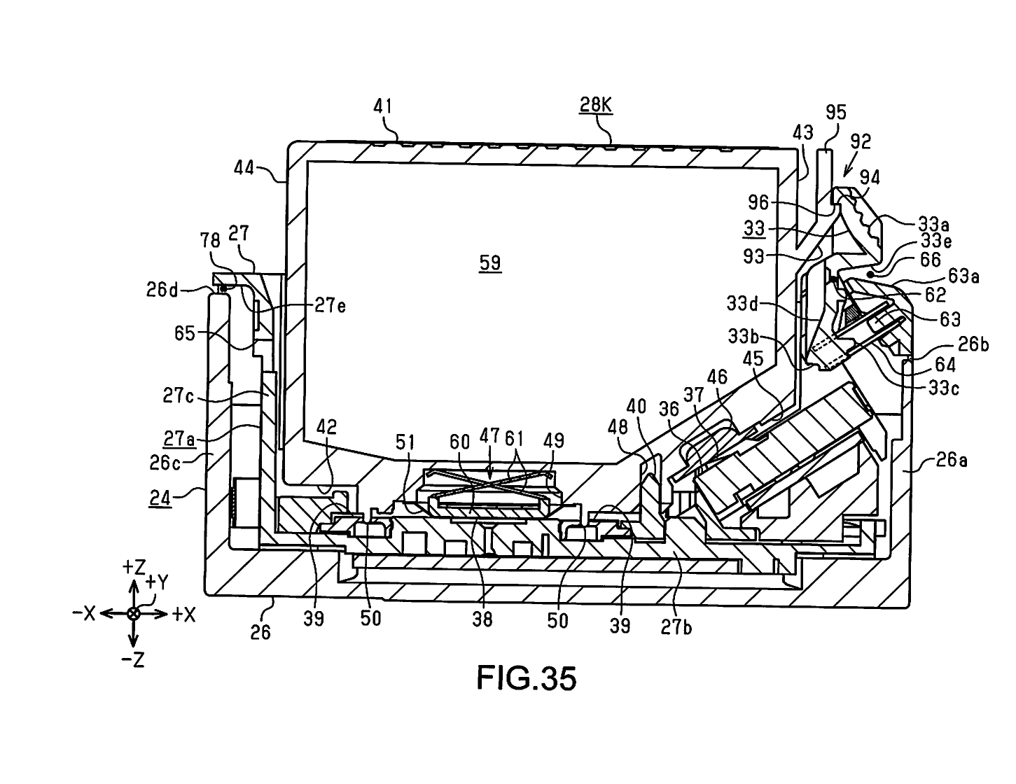

As shown in FIGS. 34 and 35, in the fifth embodiment, a liquid container 28K that is mounted to/removed from a mount portion 27 has a hook portion 92 having a different form from the hook portion 52 of the liquid container 28 shown in FIGS. 5 and 6 in the first embodiment. The hook portion 92 extends in the +Z direction and the +X direction from a +X direction side wall portion 43 in the liquid container 28K. The hook portion 92 is a lever-shaped movable engaging member. The hook portion 92 has a pair of arm portions 93 configured to elastically deform and a handle portion 95 for deforming the arm portions 93. The pair of arm portions 93 is coupled by the handle portion 95. In addition, the hook portion 92 has an engaging portion 94. The engaging portion 94 is provided on the arm portions 93.

On the other hand, as shown in FIG. 35, a step portion 96 is provided on the face on the −X direction side of the end portion on the +Z direction side of a rotation lever 33, that is, the face on the −X direction side of an operation portion 33a. In a state (mounted state) where the liquid container 28K is mounted on the mount portion 27, the engaging portion 94 of the hook portion 92 engages with the step portion 96 (engagement portion) of the rotation lever 33, and thereby movement of the liquid container 28K from the mount portion 27 in the +Z direction is restricted.

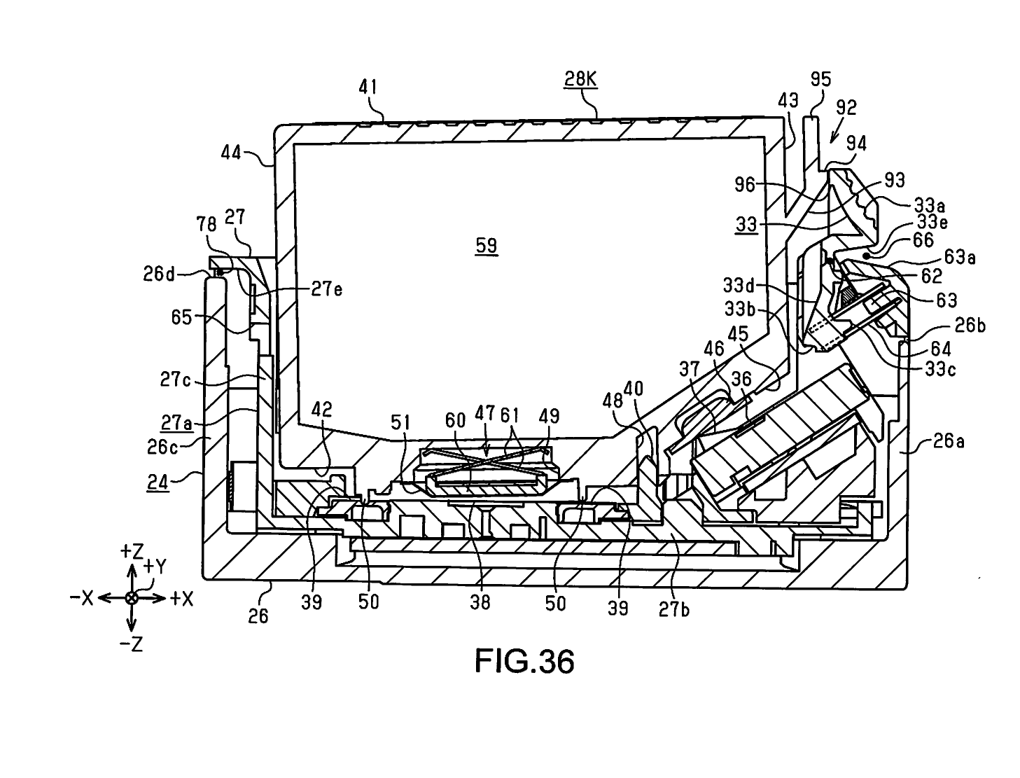

When mounting the liquid container 28K to the mount portion 27, the liquid container 28K is moved toward the bottom portion (the −Z direction) of the mount portion 27 until the engaging portion 94 of the hook portion 92 engages with the step portion 96 of the rotation lever 33. As shown in FIG. 36, during the operation of mounting the liquid container 28K, the arm portions 93 of the hook portion 92 elastically deform. Therefore, the hook portion 92 can move so as not to hinder movement of the liquid container 28K until the engaging portion 94 engages with the step portion 96 of the rotation lever 33.

When removing the liquid container 28K from the mount portion 27, the hook portion 92 is moved by pressing the handle portion 95 of the hook portion 92 in the −X direction from the state shown in FIG. 35. Engagement of the engaging portion 94 with the step portion 96 of the rotation lever 33 is then released. After that, the liquid container 28K is removed from the mount portion 27.

According to the above fifth embodiment, the following effects can be acquired.

(12) When mounting the liquid container 28K to the mount portion 27, it suffices that the liquid container 28K is moved toward the bottom portion (the −Z direction) of the mount portion 27 until the engaging portion 94 of the hook portion 92 engages with the step portion 96 of the rotation lever 33. When removing the liquid container 28K from the mount portion 27, it suffices that engagement of the engaging portion 94 with the step portion 96 of the rotation lever 33 is released by moving the hook portion 92 serving as the movable engaging member, and after that, the liquid container 28K is removed from the mount portion 27. Therefore, the operation of mounting/removing the liquid container 28K to/from the mount portion 27 can be performed easily. In addition, in a state were the hook portion 92 is in engagement with the engagement portion (the step portion 96), movement of the liquid container 28K in the +Z direction is restricted, and thus the mounted state of the liquid container 28K on the mount portion 27 can be held favorably.

In the fifth embodiment, the liquid container 28K may have, on the outer face of the +X direction side wall portion 43 thereof, a +X direction side engaging portion protruding in the +X direction as the liquid container 28A (see FIG. 14) in the second embodiment. In addition, the liquid container 28K may have, on the outer face of a −X direction side wall portion 44 thereof, a −X direction side engaging portion protruding in the −X direction, as the liquid container 28B (see FIG. 15) in the third embodiment. According to this configuration, movement, in the +Z direction, of the liquid container 28K in the mounted state is restricted by the hook portion 92, and movement in the +Z direction is also restricted by the +X direction side engaging portion and the −X direction side engaging portion. Therefore, even if an unintended external force is applied to the hook portion 92, and the hook portion 92 comes off the carriage 24, it is possible to reduce a risk that the liquid container 28K is inadvertently removed from the mount portion 27, and the mounted state of the liquid container 28K on the mount portion 27 can be held more favorably.

### Sixth Embodiment

Next, a sixth embodiment will be described below with a focus on differences from the fourth embodiment.

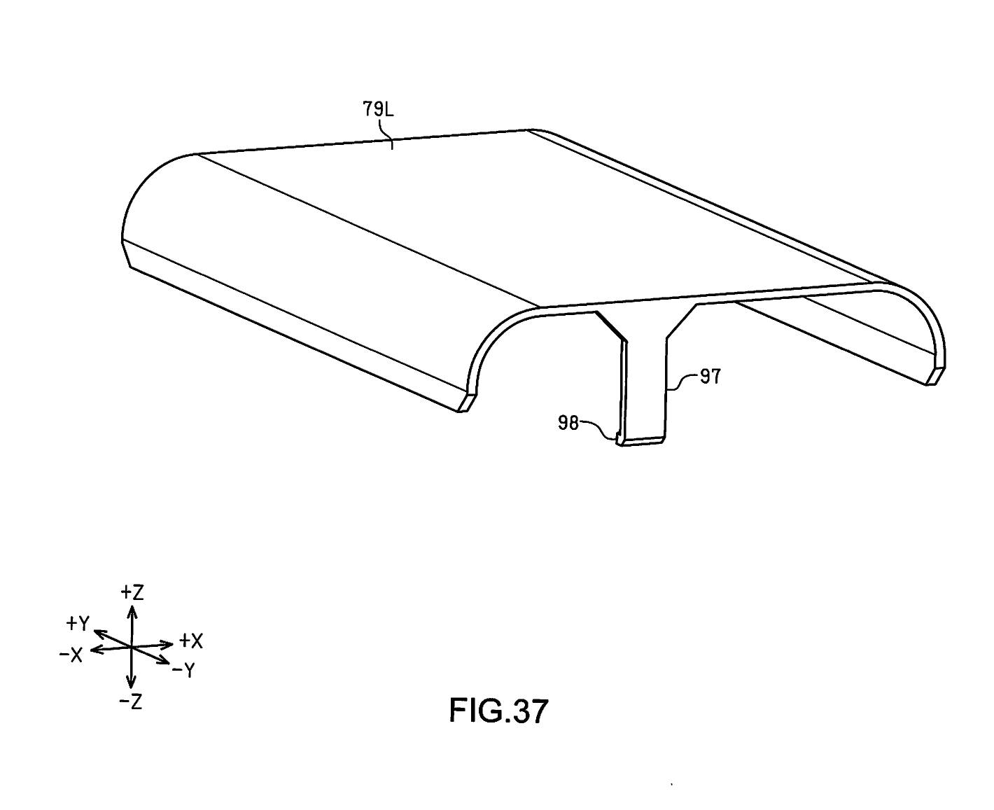

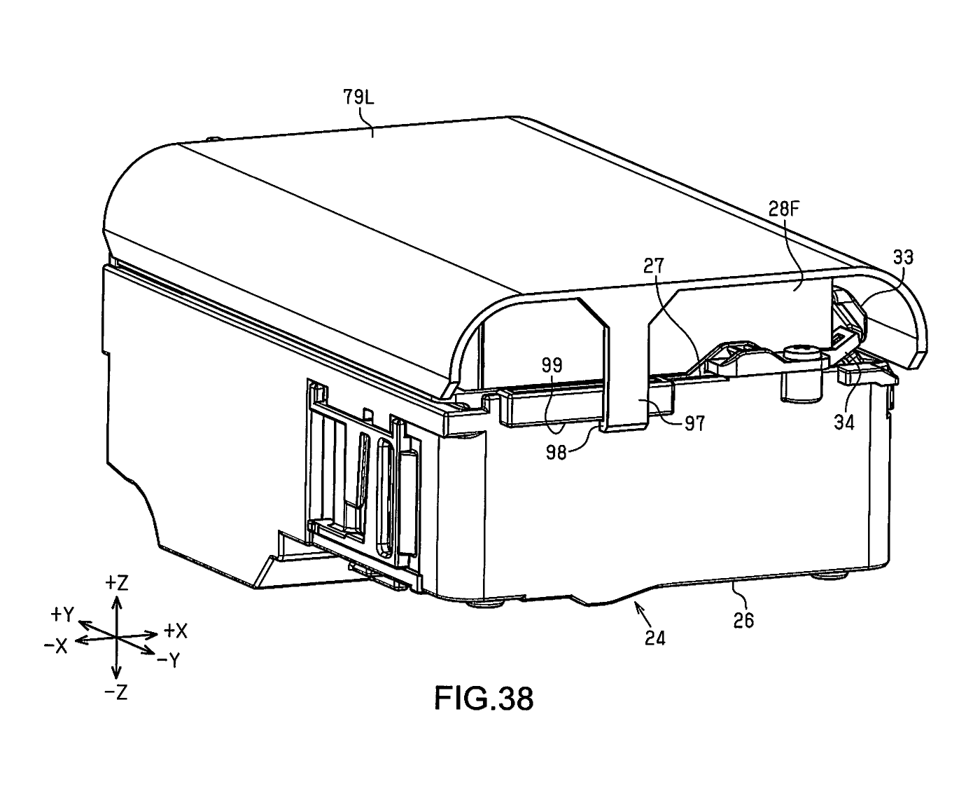

As shown in FIGS. 37 and 38, in the sixth embodiment, a cover 79L that is mounted to a carriage 24 has, in the two end portions in the Y direction thereof, hook portions 97 that have an engagement function. FIGS. 37 and 38 only show the hook portion 97 formed so as to be hung down from the end portion on the −Y direction side in the cover 79L, but the hook portion 97 that is similar is formed so as to be hung down from the end portion on the +Y direction side of the cover 79L. Nail-shaped engaging portions 98 are respectively formed at the tip ends of the hook portions 97 on the −Y direction side and the +Y direction side. The hook portions 97 are configured to restrict movement of a liquid container 28F from the mount portion 27 in the +Z direction by respectively engaging with protrusions 99 provided on the outer faces on the two sides in the Y direction of the carriage (moving body) 24 and serving as engagement portions.

According to the above sixth embodiment, the following effects can be acquired.

(13) When mounting the liquid container 28F to the mount portion 27, it suffices that the liquid container 28F is arranged in the mount portion 27, and after that, the cover 79L that covers the liquid container 28F is mounted such that the hook portions 97 of the cover 79L engage with the engagement portions (the protrusions 99) of the carriage (moving body) 24. On the other hand, when removing the liquid container 28F from the mount portion 27, the liquid container 28F can be removed from the mount portion 27 by moving the cover 79L in a direction in which the engagement state of the hook portions 97 with engagement portion (the protrusions 99) is released. Therefore, the operation of mounting/removing the liquid container 28F to/from the mount portion 27 can be performed easily. In addition, in a state where the hook portions 97 of the cover 79L are in engagement with the engagement portions (the protrusion 99), movement of the liquid container 28F in the +Z direction is restricted by the cover 79L, and thus the mounted state of the liquid container 28F on the mount portion 27 can be held favorably.

Note that the above sixth embodiment may be changed as follows.

### Modified Example 11

(i) The position at which the hook portion 97 is engaged is not limited to the above-described protrusion 99. For example, the hook portion 97 may be configured to engage with a portion of the outer face in the Y direction of the carriage (moving body) 24 (for example, an engagement portion formed in a step-like shape or a shape of a recessed or projected portion, on the wall face portion on the +Y direction side of the carriage 24 or the outer face on the −Y direction side).

(ii) Similarly to the above Modified Example 10-(iii), the cover 79L does not need to cover the entirety of the +Z direction side wall portion of the liquid container 28F. Accordingly, when the cover 79L is mounted to the carriage 24, it suffices that the cover 79L covers the +Z direction side wall portion 41 of the liquid container 28F to an extent where movement, in the +Z direction, of the liquid container 28F arranged in the mount portion 27 can be restricted.

(iii) Modification similar to the above Modified Example 10-(iv) can be applied to the sixth embodiment.

What is claimed is:

1. A liquid container configured to be mounted to/removed from a mount portion of a liquid ejection apparatus including: a box; a head that ejects liquid; a moving body that is equipped with the head, and moves along a X direction in the box, and when the liquid is not ejected from the head, stands by in an end portion on a +X direction side in the box; a mount portion provided on the moving body; and a rotation lever provided at a position on the +X direction side in the mount portion so as to be rotatable centered on a shaft line along a Y direction,
when the vertical direction is assumed to be a Z direction, a direction orthogonal to the Z direction is assumed to be the X direction, a direction orthogonal to both the Z direction and the X direction is assumed to be the Y direction, the vertical upward direction in the Z direction is assumed to be a +Z direction, while the vertical downward direction is assumed to be a −Z direction, the positive direction in the X direction is assumed to be the +X direction, while the negative direction is assumed to be a −X direction, and a state where the liquid container is mounted on the mount portion is assumed to be a mounted state,
the liquid container in the mounted state including:
a +Z direction side wall portion that is positioned on the +Z direction side;
a +X direction side wall portion that is positioned on the +X direction side; and
a hook portion provided on one of the +Z direction side wall portion and the +X direction side wall portion, the hook portion configured to engage with an engagement portion constituted by one of:
an outer face on the +X direction side in the moving body,
an outer face on the +X direction side in the rotation lever, and
a gap in the Z direction formed between a wall on the +X direction side of the moving body and the rotation lever
so as to restrict movement of the liquid container from the mount portion in the +Z direction.

2. The liquid container according to claim 1,
wherein a +X direction side engaging portion is provided on the +X direction side wall portion, and
in the mounted state, the +X direction side engaging portion engages with a +X direction side engagement portion provided in the rotation lever in a state of abutting against the +X direction side engagement portion from the −Z direction side.

3. The liquid container according to claim 1, further comprising:
a −X direction side wall portion positioned on the −X direction side in the mounted state,
wherein a −X direction side engaging portion is provided on the −X direction side wall portion, and
in the mounted state, the −X direction side engaging portion engages with a −X direction side engagement portion provided in a side wall on the −X direction side of the mount portion in a state of abutting against the −X direction side engagement portion from the −Z direction side.

4. The liquid container according claim 1,
wherein the hook portion configured to rotate centered on a shaft along the Y direction,
the hook portion has an engaging portion that engages with the engagement portion, and an operation portion provided at a position on the opposite side to the engaging portion with the shaft therebetween,
the operation portion is biased by a biasing member in a direction in which the engaging portion engages with the engagement portion, and
engagement of the engaging portion with the engagement portion is released by shifting the operation portion against a biasing force of the biasing member.

5. The liquid container according claim 1,
wherein the mount portion is configured such that a plurality of the liquid containers are mounted so as to be aligned in the Y direction, and a plurality of the rotation levers are provided in the mount portion at positions corresponding to the liquid containers, and
the hook portion is configured to be engaged at a position between the rotation levers adjacent in the Y direction in the mount portion.

6. The liquid container according claim 1,
wherein the mount portion is configured such that a plurality of the liquid containers are mounted so as to be aligned in the Y direction, and a plurality of the rotation levers are provided in the mount portion at positions corresponding to of the liquid containers, and
the hook portion is configured to extend in the −Z direction while passing between the rotation levers adjacent in the Y direction in the mount portion, then curve in the Y direction, and engage with the engagement portion.

7. A liquid ejection apparatus comprising:
when the vertical direction is assumed to be a Z direction, a direction orthogonal to the Z direction is assumed to be an X direction, a direction orthogonal to both the Z direction and the X direction is assumed to be a Y direction, the vertical upward direction in the Z direction is assumed to be a +Z direction, while the vertical downward direction is assumed to be a −Z direction, and the positive direction in the X direction is assumed to be a +X direction, while the negative direction is assumed to be a −X direction,
a box; a head that ejects liquid; a moving body that is equipped with the head, and moves along the X direction in the box, and when the liquid is not ejected from the head, stands by in an end portion on the +X direction side in the box; a mount portion provided on the moving body such that a liquid container configured to be mounted and removed; and a rotation lever provided at a position on the +X direction side in the mount portion so as to be rotatable centered on a shaft line along the Y direction, and
when a state where the liquid container is mounted to the mount portion is assumed to be a mounted state, a cover that covers, in the mounted state, a wall portion on the +Z direction side of the liquid container is attached to the moving body,
the cover has a hook portion having an engagement function, and
the hook portion is configured to engage with an engagement portion constituted by one of:
an outer face on the +X direction side in the moving body;
an outer face on the +X direction side in the rotation lever, and
a gap in the Z direction formed between a wall on the +X direction side of the moving body and the rotation lever
so as to restrict movement of the liquid container from the mount portion in the +Z direction.

8. The liquid ejection apparatus according to claim 7,
wherein the hook portion configured to rotate centered on a shaft along the Y direction,
the hook portion has an engaging portion that engages with the engagement portion, and an operation portion provided at a position on the opposite side to the engaging portion with the shaft therebetween,
the operation portion is biased by a biasing member in a direction in which the engaging portion engages with the engagement portion, and
engagement of the hook portion with the engagement portion is released by shifting the operation portion against a biasing force of the biasing member.

9. The liquid ejection apparatus according to claim 7,
wherein the mount portion is configured such that a plurality of the liquid containers are mounted so as to be aligned in the Y direction, and a plurality of the rotation levers are provided in the mount portion at positions corresponding to the liquid containers, and
the hook portion is configured to be engaged at a position between the rotation levers adjacent in the Y direction in the mount portion.

10. The liquid ejection apparatus according to claim 7,
wherein the mount portion is configured such that a plurality of the liquid containers are mounted so as to be aligned in the Y direction, and a plurality of the rotation levers are provided in the mount portion at positions corresponding to the liquid containers, and
the hook portion is configured to extend in the −Z direction while passing between the rotation levers adjacent in the Y direction in the mount portion, then curve in the Y direction, and engage with the engagement portion.

11. The liquid ejection apparatus according to claim 7,
wherein an end portion on the −X direction side of the cover is supported by an outer face on the −X direction side in the moving body so as to be rotatable centered on the shaft along the Y direction.

12. A liquid container configured to be mounted to/removed from a mount portion of a liquid ejection apparatus including: a box; a head that ejects liquid; a moving body that is equipped with the head, and moves along a X direction in the box, and when the liquid is not ejected from the head, stands by in an end portion on a +X direction side in the box; a rotation lever provided at a position on the +X direction side in the mount portion so as to be rotatable centered on a shaft line along a Y direction; and a step portion provided on a face on a −X direction side of an end portion on a +Z direction side of the rotation lever,
when the vertical direction is assumed to be a Z direction, a direction orthogonal to the Z direction is assumed to be the X direction, a direction orthogonal to both the Z direction and the X direction is assumed to be the Y direction, the vertical upward direction in the Z direction is assumed to be the +Z direction, while the vertical downward direction is assumed to be a −Z direction, the positive direction in the X direction is assumed to be the +X direction, while the negative direction is assumed to be the −X direction, and a state where the liquid container is mounted on the mount portion is assumed to be a mounted state,
the liquid container in the mounted state including:
a +X direction side wall portion that is positioned on the +X direction side,
a hook portion is provided on the +X direction side wall portion,
the hook portion is constituted by a movable engaging member having an engaging portion that engages with the step portion of the rotation lever, and
the hook portion is configured to restrict movement of the liquid container from the mount portion in the +Z direction, by the engaging portion engaging with the step portion of the rotation lever.

13. A liquid ejection apparatus comprising:
when the vertical direction is assumed to be a Z direction, a direction orthogonal to the Z direction is assumed to be an X direction, a direction orthogonal to both the Z direction and the X direction is assumed to be a Y direction, the vertical upward direction in the Z direction is assumed to be a +Z direction, while the vertical downward direction is assumed to be a −Z direction, and the positive direction in the X direction is assumed to be a +X direction, while the negative direction is assumed to be a −X direction,
a box; a head that ejects liquid; a moving body that is equipped with the head, and moves along the X direction in the box, and when the liquid is not ejected from the head, stands by in an end portion on the +X direction side in the box; a mount portion provided on the moving body; and a rotation lever provided at a position on the +X direction side in the mount portion so as to be rotatable centered on a shaft line along the Y direction,
wherein a cover that covers a wall portion on the +Z direction side of a liquid container is attached to the moving body in a mounted state in which the liquid container is mounted on the mount portion,
hook portions having an engagement function are provided respectively in two end portions in the Y direction of the cover, and
the hook portions are configured to respectively engage with outer faces on two sides in the Y direction of the moving body so as to restrict movement of the liquid container from the mount portion in the +Z direction.
